(19) United States
(12) Patent Application Publication
(10) Pub. No.: US 2006/0117343 A1
(43) Pub. Date: Jun. 1, 2006

(54) Apparatus and methods for advertising in a sequential manner and based upon user preference

(75) Inventors: Robert E. Novak, Santa Clara, CA (US); James A. Billmaier, Woodinville, WA (US); Anthony F. Istvan, Snoqualmie, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Digeo, Inc., Kirkland, WA (US)

(21) Appl. No.: 10/124,808

(22) Filed: Apr. 16, 2002

Related U.S. Application Data
(63) Continuation-in-part of application No. 10/124,806, filed on Apr. 16, 2002.
(60) Provisional application No. 60/284,329, filed on Apr. 17, 2001.

(51) Int. Cl. G06F 13/00

(52) U.S. Cl. 725/38

(57) ABSTRACT

A method of providing video enhancement to an interactive content page, the method comprising: providing a graphical overlay with a plurality of transparent sections; providing a graphical underlay capable to show a plurality of underlay contents; displaying a first underlay content in a first one of the transparent sections; and displaying a second underlay content in a second one of the transparent sections in sequence after displaying the first underlay content. An apparatus for providing a video enhancement to an interactive television content page, includes a display engine capable to display a graphical overlay having an associated transparent section, where different underlay contents are displayed on a graphical underlay and through the associated transparent section in a sequential manner; and a processor communicatively coupled to the display engine and capable to execute the display engine.

### CROSS-REFERENCE TO RELATED APPLICATIONS

This application claims priority to U.S. Provisional Application Ser. No. 60/284,329, by common inventors James A. Billmaier, Anthony F. Istvan, and Robert E. Novak, filed Apr. 17, 2001, entitled “HOLE IN WINDOW,” and assigned to the same assignee as the present application. Application Ser. No. 60/284,329 is fully incorporated herein by reference.

This application is a continuation-in-part of and further claims the benefit of U.S. patent application Ser. No. ______, Attorney Docket No. 260042.496 (digeo Reference No. 247.1), entitled “APPARATUS AND METHODS FOR ADVERTISING IN A TRANSPARENT SECTION IN AN INTERACTIVE CONTENT PAGE,” by inventors James A. Billmaier, Anthony F. Istvan, and Robert E. Novak, filed ______, 2002 (Express Mail Label No. EV064990413US), and assigned to the same assignee as the present application. This parent application Ser. No. ______ is fully incorporated herein by reference.

### BACKGROUND OF THE INVENTION

1. Field of the Invention

This disclosure relates generally to electronics and communications, and more particularly to interactive television (iTV) systems.

2. Description of the Related Art

An interactive television system typically includes a customer premise equipment such as a set top box (STB). Low-power or limited-capability STBs can display graphics pages that are static or that change little over time. However, these types of STBs have so far been limited in their capability to display multi-media content or high quality video.

The restricted types of multimedia and video so far available in graphics pages displayed by low-power interactive television systems limit the visual interest and advertising value of those graphics pages. For example, motion video advertisements (such as television commercials) are more visually interesting and are thought to be substantially more effective at getting a viewer's attention than static advertisements (such as banner ads), but are not typically available given the restrictions of low-power or limited-capability interactive television systems.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic block diagram of a video casting network according to an embodiment of the invention.

FIG. 2 is a block diagram of an interactive television client system according to an embodiment of the invention.

FIG. 3 is a block diagram of a set top box (or other customer premise equipment) according to an embodiment of the invention.

FIG. 4 is a block diagram of a memory device that is capable to store various codes (or modules) or data according to an embodiment of the invention.

FIG. 5A is a block diagram illustrating underlay content displayed in an area of a graphical underlay (video backplane).

FIG. 5B is a block diagram illustrating an interactive content page with a transparent section showing the underlay content of FIG. 5A.

FIG. 6 is a flowchart illustrating an advertising method according to an embodiment of the invention.

FIG. 7A is a block diagram illustrating underlay contents composited as a single video and displayed in various areas of a graphical underlay (video backplane).

FIG. 7B is a block diagram illustrating an interactive content page (A) with a transparent section showing an underlay content.

FIG. 7C is a block diagram illustrating another interactive content page (B) with a transparent section showing an underlay content.

FIG. 7D is a block diagram illustrating another interactive content page (C) with a transparent section showing an underlay content.

FIG. 7E is a block diagram illustrating another interactive content page (D) with a transparent section showing an underlay content.

FIG. 7F is a block diagram illustrating another interactive content page (E) with multiple transparent sections, where each transparent section shows a different underlay content.

FIG. 8 is a flowchart illustrating an advertising method according to another embodiment of the invention.

FIG. 9 is a flowchart illustrating an advertising method based on the use of triggers, in accordance with an embodiment of the invention.

FIG. 10 is a block diagram of a memory device that is capable to store various codes (or modules) or data according to another embodiment of the invention.

FIG. 11 is a block diagram illustrating the sequencing of underlay contents in accordance to an embodiment of the invention.

FIG. 12 is another block diagram illustrating the sequencing of underlay contents.

FIG. 13 is a block diagram illustrating the sequencing of underlay contents, where a first content is shown through a first transparent section in accordance with an embodiment of the invention.

FIG. 14 is a block diagram illustrating the sequencing of underlay contents where a second content is shown through a second transparent section.

FIG. 15 is a block diagram illustrating the sequencing of underlay contents where a third content is shown through a third transparent section.

FIG. 16 is a block diagram illustrating the sequencing of underlay contents where a fourth content is shown through a fourth transparent section.

FIG. 17 is a block diagram illustrating the sequencing of underlay contents where a fifth content is shown through the first transparent section.

FIG. 18 is a flowchart illustrating a method of sequencing of underlay contents in accordance with an embodiment of the invention.

FIG. 19 is a flowchart illustrating a method of sequencing of underlay contents in accordance with another embodiment of the invention.

FIG. 20 is a flowchart illustrating a method of tracking the previously shown underlay contents in accordance with an embodiment of the invention.

FIG. 21 is a flowchart illustrating a method of tracking the previously shown underlay contents in accordance with another embodiment of the invention.

FIG. 22 is a block diagram illustrating the showing of underlay contents based on user preference information, in accordance with an embodiment of the invention.

FIG. 23 is a block diagram illustrating the showing of underlay contents based on user preference information, where the contents are broadcast by another channel.

FIG. 24 is a flowchart illustrating a method of showing underlay contents based on user preference information, in accordance with an embodiment of the invention.

FIG. 25 is a block diagram illustrating the showing of underlay contents based on user preference information, in accordance with another embodiment of the invention.

FIG. 26 is a block diagram illustrating the showing of underlay contents based on user preference information where a subsequent underlay content based on user preference information may be shown.

FIG. 27 is a block diagram illustrating the showing of underlay contents based on user preference information, in accordance with another embodiment of the invention.

FIG. 28 is a flowchart illustrating a method of showing underlay contents based on user preference information, in accordance with another embodiment of the invention.

FIG. 29 is a flowchart illustrating a method of showing of underlay contents based on user preference information, in accordance with another embodiment of the invention.

### DETAILED DESCRIPTION

Embodiments of an apparatus and/or method for providing high quality video advertisements in an interactive television system are disclosed herein. As an overview, an embodiment of the invention provides an apparatus and method that permit video enhancements to otherwise static interactive television (iTV) content pages for systems with limited resources. A graphical overlay (on a graphical foreplane) that shows an interactive content page may include a transparent section that can display content being broadcast in a graphical underlay (e.g., a video backplane). The transparent section may be, for example, a transparent hole or window that permits the viewing of at least a portion of the graphical underlay. The transparent section permits the display of underlay content (e.g., a video advertisement) being shown on the graphical underlay. The underlay content can be scaled and/or formatted (and/or zoomed, cropped, and/or repositioned) to fit within the dimensions of the transparent section of the interactive content page. The interactive content page is typically shown via a first channel, while the underlay content can be shown via a second channel that may be, for example, a video channel dedicated for broadcasting advertisement content.

In one embodiment, a set top box (or other customer premise equipment) can silently tune to the channel that is broadcasting the underlay content.

In another embodiment, at least one interactive content page can be selected (viewed) from a selection of multiple interactive content pages, where each interactive content page has an associated transparent section for displaying underlay content. The displayed underlay content may, for example, typically relate to the selected (viewed) interactive content page.

In another embodiment, an interactive content page may include multiple transparent sections, where each transparent section shows a different underlay content.

In another embodiment, an interactive content page may include a plurality of transparent sections. Different underlay contents may be shown in a carousel motion or sequential manner in the transparent sections. Thus, a sequence of advertisements can be seen through the transparent sections.

In another embodiment, user preference data can be tracked or gathered. An underlay content that is shown in a transparent section of an interactive content page may relate to the user preference data. Thus, advertisements or other underlay contents that are shown through a transparent section may be personalized (or targeted) for the particular user/viewer.

Embodiments of the invention may be particularly useful for thin client solutions (or limited-capability STBs or other customer premise equipment) where, for example, the central processing unit capacity for handling streaming video or Flash-based commercials is not available. Thus, an embodiment of the invention permits the showing of compelling visuals even on “thin” client set top boxes. As an example, high quality advertisements may be shown through a transparent section in a graphics menu page or other interactive content pages.

In the description herein, numerous specific details are provided, such as examples of components and/or methods, to provide a thorough understanding of embodiments of the invention. One skilled in the relevant art will recognize, however, that embodiments of the invention can be practiced without one or more of the specific details, or with other apparatus, systems, methods, components, materials, parts, and/or the like. In other instances, well-known structures, materials, or operations are not shown or described in detail to avoid obscuring aspects of the invention.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

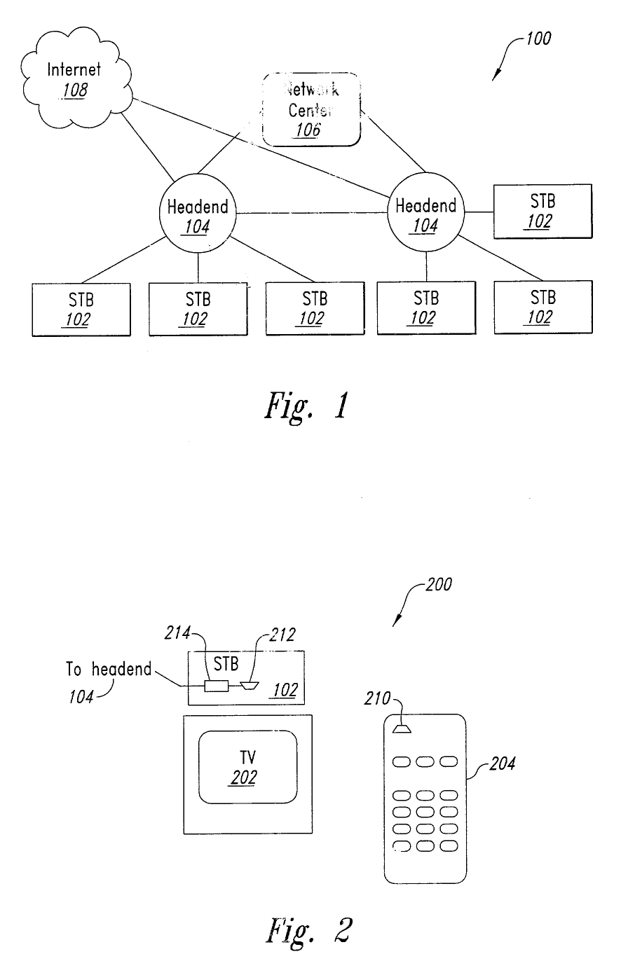

Referring now to FIG. 1, there is shown a block diagram of a video casting network 100, such as a cable network, that can implement a specific embodiment of the invention. Of course, the illustrated network topology is provided for example purposes only, and other network topologies may be used within the scope of the invention. In one implementation, the network 100 includes a plurality of set top boxes (STBs) 102 or other types of customer premises equipment (CPE) located, for instance, at customer homes. Generally, an STB 102 is a consumer electronics device that serves as a gateway between a customer's television and a broadband communication network, such as a cable network. As its name implies, an STB 102 is typically located on top of, or in close proximity to, a customer's television. Alternatively, the features of an STB 102 can be built into the circuitry of the television (e.g., an interactive television set).

In one embodiment, an STB 102 receives encoded video/audio signals (including television signals) from the network 100 and decodes the signals for display on the television. Additionally, an STB 102 receives commands from a user (typically via a remote control device) and transmits such commands back to the network 100.

In various embodiments, each STB 102 is connected to a headend 104. In the context of a cable network, a headend 104 is a centrally-located facility where digital and analog cable TV (CATV) channels are received from a local CATV satellite downlink and packaged together for transmission to customer homes. In this case, a headend 104 functions as a local digital broadcast center.

The headends 104 may be coupled directly to one another or through a network center 106. In some cases, the headends 104 may be connected via a separate network, such as, for example, the Internet 108.

As described in detail hereafter, each STB 102 may be identified by a unique number, code, or address, such as an IP (Internet Protocol) address. Thus, a user of one STB 102 may indicate a particular STB 102 to receive an audio or video transmission by specifying the corresponding address. The network 100 then routes the transmission to its destination using conventional techniques.

As an alternative to the cable network, other video casting networks may be used in accordance with other embodiments of the invention. For example, satellite TV delivery systems may be used. A satellite TV delivery system may include a direct broadcast satellite (DBS) system. A DBS system may include, for example, a small 18-inch satellite dish (which is an antenna that can receive a satellite broadcast signal); a digital integrated receiver/decoder (IRD), which separates each channel, and decompresses and translates the digital signal so that a television can show the digital signal; and a remote control device that transmits command signals. Programming for a DBS system may be distributed by, for example, multiple high-powered satellites in geo-synchronous orbit, with each satellite having multiple transponders. Compression (e.g., Moving Pictures Experts Group (MPEG) based compression) may be used to increase the amount of programming content that can be transmitted in the available bandwidth.

A digital broadcast center may be used to gather programming content, ensure the digital quality of the programming content, and transmit the signal up to the satellites for delivery. Programming content may be provided to the broadcast center from content providers (e.g., ABC, CNN, ESPN, and so on) via satellite, fiber optic cable, and/or special digital tape. Satellite-delivered programming content are typically immediately digitized, encrypted, and up-linked to the orbiting satellites. The satellites re-transmit the signal back down to every earth-station (or, in other words, every compatible DBS system receiver dish at, for example, homes and businesses of customers).

Some programming content may be recorded on digital videotape in the broadcast center, and the programming content can be broadcast at a later time or day. Before any recorded programming content are viewed by customers, technicians may use post-production equipment to view and analyze each tape to, for example, ensure audio and video quality. Tapes may then be loaded into, for example, a robotic tape handling system, and playback may be triggered by a computerized signal sent from a broadcast automation system. Back-up videotape playback equipment may ensure uninterrupted transmission at all times.

Referring now to FIG. 2, there is shown a block diagram of various components of an interactive television client system 200 according to a specific embodiment of the invention. The client system 200 typically includes a television 202, which is configured to receive and display, for example, standard analog or digital television signals or high-definition television (HDTV) signals. In this embodiment, the client system 200 includes an STB 102 with a tuner system 214 for receiving and demodulating video, audio, and/or other data from the network 100. The tuner system 214 may include a digital tuner configured to tune to a digital channel of the video casting network 100. Such digital channels typically broadcast compressed digital video to set top boxes. The tuner system 214 may also include an analog tuner configured to tune to an analog TV channel of the video casting network and to extract an analog TV signal therefrom. Such an analog tuner makes the STB 102 “backward compatible” with analog TV broadcasts.

In one embodiment, a remote control device 204 is provided for convenient remote operation of the STB 102 and the television 202. The remote control device 204 may communicate with the STB 102 and television 202 by using conventional techniques to adjust, for example, the volume of the television, the displayed channel, and the like. Such communication may occur, for example, by way of control codes being transmitted from a command transmitter 210 on the remote control device 204 to a command receiver 212 in the STB 102. The transmitter 210 and receiver 212 may include, for example, infrared or radio frequency communication devices.

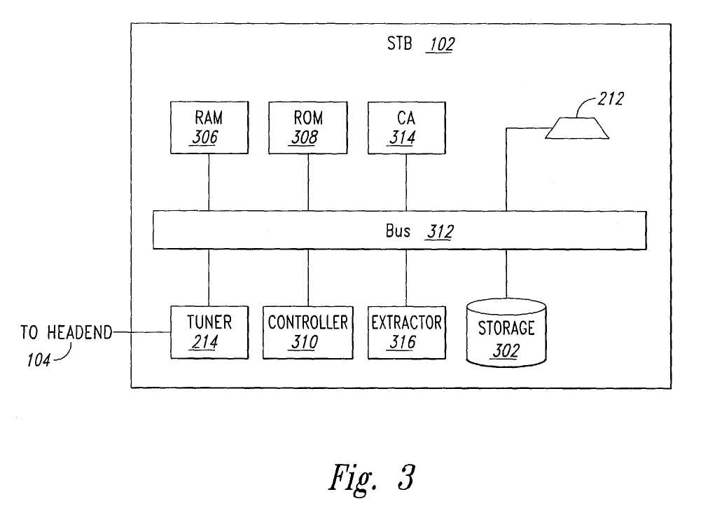

FIG. 3 illustrates an expanded diagram of a representative set top box (or other suitable customer premise equipment or processing device) 102 according to a specific embodiment of the invention. It is noted that the illustrated configuration of the set top box (STB) 102 in FIG. 3 is provided for example purposes only, and other types of configurations may be used within the scope of the invention. It is also noted that the components shown in FIG. 3 may be implemented in other types of customer premise equipment or other types of processing devices. The STB 102 includes a controller 310 that is in communication with the receiver 212, the tuner system 214, a storage system 302, a random access memory (RAM) 306, and a read only memory (ROM) 308. The controller 310 may be coupled to the other components of the STB 102, for example, via a bus 312.

In various embodiments, the controller 310 may be embodied as a microcontroller, a microprocessor, a digital signal processor (DSP) or other device known in the art. The controller 310 manages the operation of the STB 102, including, for example, the transmission and reception of video/audio/data information from the network 100, the storage of the video/audio/data information, and the like. As noted above, the controller 310 may perform these and other operations based on, for example, the control signals generated by the remote control device 204 (FIG. 2) and transmitted to the receiver 212.

The controller 310 can execute instructions stored in the storage system 302, ROM 308, and/or RAM 306 to achieve particular functions that will be discussed in further detail below. The controller 310 also typically performs other management functions of the STB 102. The controller 310 may also permit the tuner system 214 to tune to a channel transmitting content that is to be displayed on the television 202, or to switch from one channel to another channel transmitting content to be displayed on the television 202.

The RAM 306 may be configured to store data for temporary use. Similarly, the ROM 308 may be provided for storing more permanent data, such as fixed code and configuration information. In one embodiment, the ROM 308 may be used to store an operating system for the STB 102. Examples of suitable operating systems include Windows CE® or Linux®.

The storage system 302 may be, for example, a hard disk drive, a removable memory device, or any other suitable organization of volatile or non-volatile memory. Such a storage system 302 may be used, for example, to store digital video for later viewing by a user. In another embodiment, the storage system 302 may be located externally from the STB 102.

In one embodiment, the STB 102 further includes a conditional access (CA) system 314 coupled to the tuner system 214. The CA system 314 restricts channels accessible by the STB 102 to authorized channels only. The CA system 314 may be implemented by using software and/or components available, for example, from MOTOROLA or SCIENTIFIC ATLANTA. A typical CA system 314 operates in cooperation with a corresponding CA server in a cable head-end 104.

In addition, the STB 102 may include a cable modem (not shown in the drawings) coupled to the video casting network 100 (FIG. 1), and typically coupled to the network 100 via the same RF cable as used to couple the tuner system 214 to the network 100. The cable modem is configured to receive digital data by demodulating an analog signal received from the network 100 and to transmit digital data by modulating the digital data to create an analog signal for transmission to the network 100. The cable modem may be implemented by using, for example, the DOCSIS or DAVIC standards. A typical cable modem operates in cooperation with a cable modem termination system at a cable headend 104.

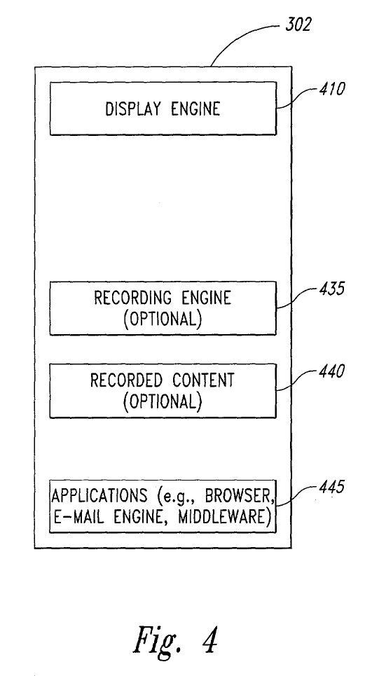

FIG. 4 is a block diagram of various applications that may be stored in a storage device (e.g., storage system 302 or RAM 306). For purposes of explaining the functionalities of an embodiment of the invention, it is assumed that the various applications are stored in, for example, the storage system 302. A display engine 410 permits the controller 310 to perform at least one of the following functions: (1) to switch between or select channels that transmit content for display on a display device such as a television 202; (2) to display a graphical overlay (e.g., an interactive content page) from a first channel and/or underlay content from a second channel; (3) to format the graphical overlay so that a transparent section is included in the graphical overlay; and/or (4) to format and scale the underlay content displayed through the transparent section of the graphical overlay. As noted below, at least some of the functions described in (2) through (4) above may be performed by components and/or software at an upstream stage such as a broadcast center (e.g., a cable head end 104).

It is noted that the display engine 410 may instead be hardware and/or software that is implemented as part of the controller 310. Therefore, the display engine 410 is shown as a separate module in the example in FIG. 4 for purposes of describing the functionalities of an embodiment of the present invention and should not be construed as limiting the scope of the present invention. The display engine 410 may typically perform the functions of a graphics engine and/or a video engine. Other functions that may be performed by the display engine 410 are described below.

An optional recording engine 435 may perform functions such as recording commercial content or copying data files as recorded content 440.

Other applications 445 may represent one or more applications. The applications 445 may include, for example, a browser for accessing a Uniform Resource Locator (URL) address on the Internet and for permitting web pages in a URL address to be displayed on the screen of the television 202. The applications 445 may also include an e-mail engine that can detect when an electronic mail (e-mail) message has been received by the set top box 102. The email engine can also permit the display of an e-mail message on the screen of the television 202, the creation and transmission of an e-mail message from the STB 202, and/or other e-mail processing functions. The applications 445 may also include middleware (sometimes called “plumbing”) for connecting two sides of an application and passing data between them. The applications 445 may also include other engines that are used in the typical operation of a customer premise equipment (such as an STB), and/or other engines that permit other external components to function with the components of an STB.

The various engines discussed herein may be, for example, software, commands, data files, programs, code, modules, instructions, or the like, and may also include suitable mechanisms. It is noted that the modules shown in FIG. 4, such as the recording engine 435, may instead be hardware and/or software that is implemented as part of the controller 310 or as part of other suitable components that interact with the set top box 102. Additionally, the various functionalities of the separate modules in FIG. 4 may be combined in one or more modules. Therefore, the various modules in FIG. 4 are shown only as examples and as separate drawing blocks for purposes of describing the functionalities of an embodiment of the present invention and should not be construed as limiting the scope of the present invention.

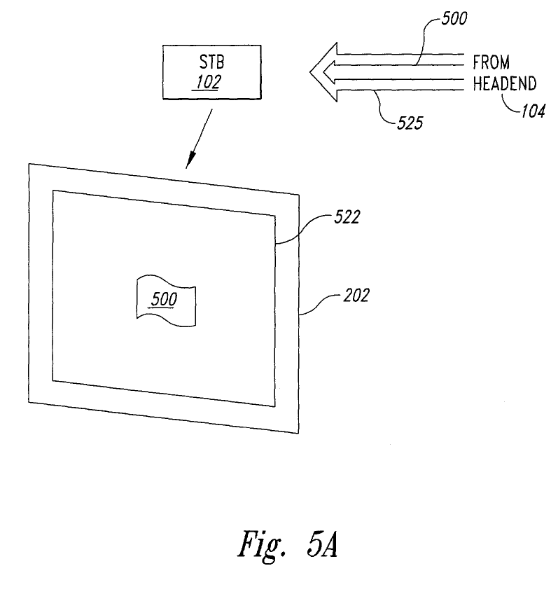

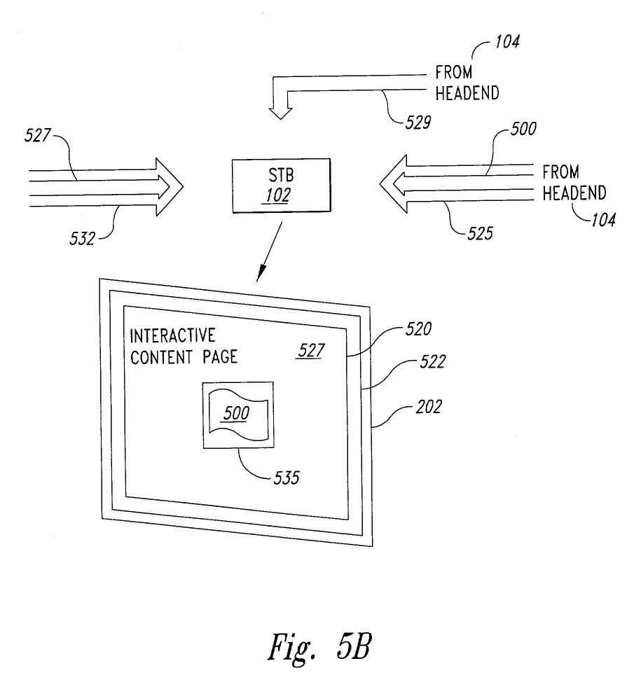

FIGS. 5A to 5B are block diagrams illustrating an operation of a specific embodiment of the invention. Various embodiments of the invention advantageously provide, for example, a method of delivering high quality video motion advertising as seen through a transparent section 535 (FIG. 5B) in an interactive content page 527 or other graphical overlay. The interactive content page 527 may be shown, for example, on the television 202 screen (FIG. 2).

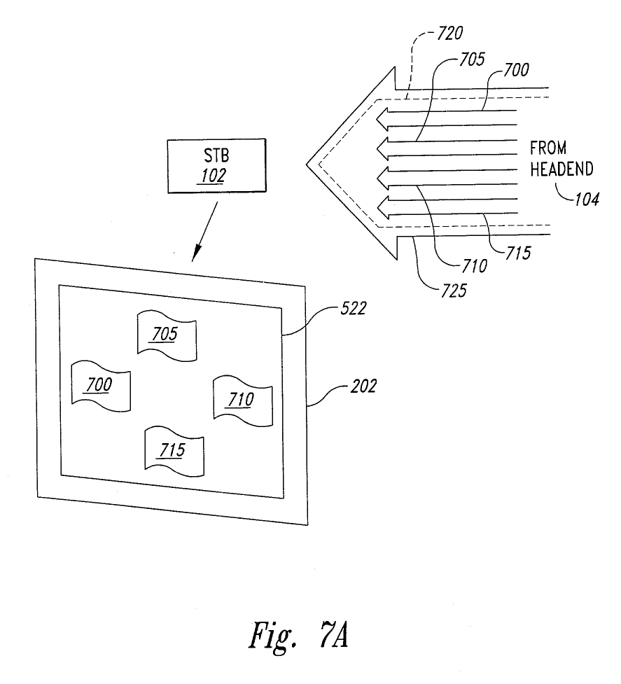

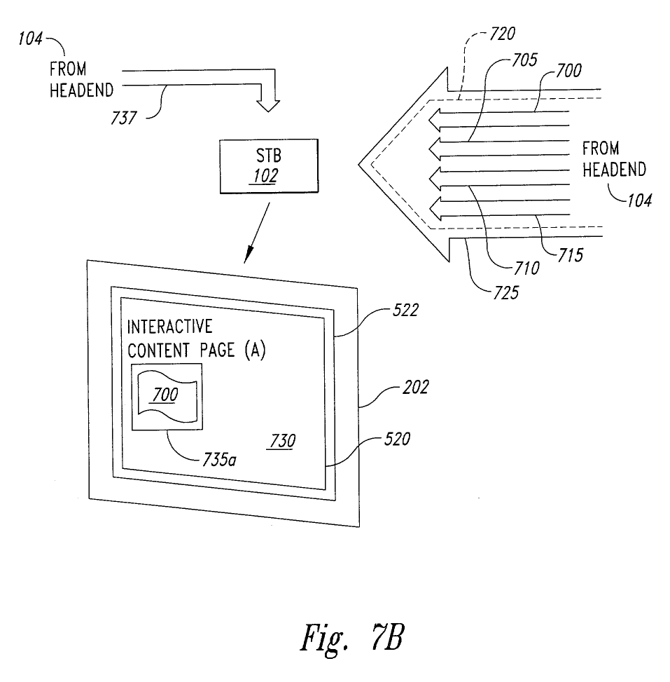

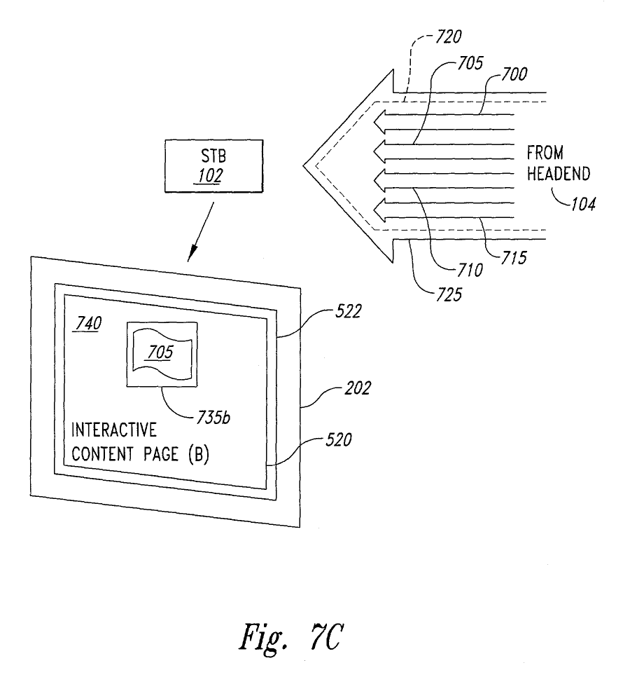

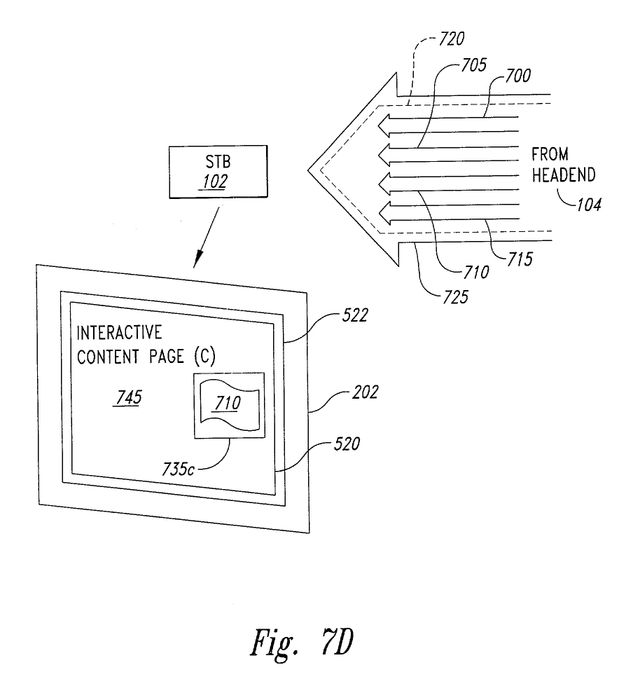

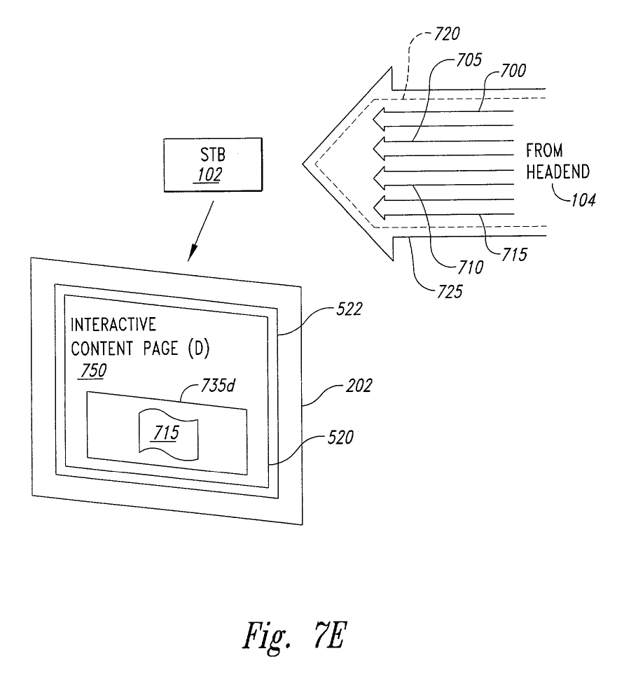

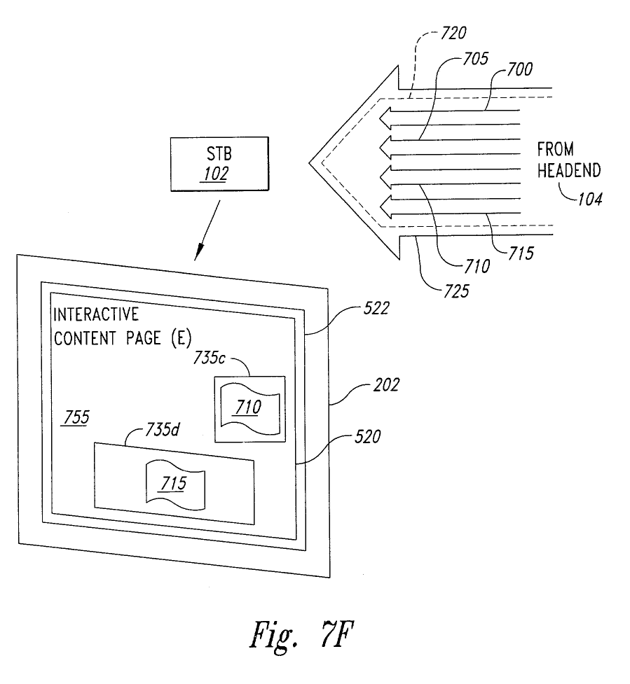

Referring first to FIG. 5A, an underlay content 500 is transmitted from the headend 104 (or from a digital broadcast center in other implementations) to the STB 102. The underlay content 500 is displayed an area of a graphical underlay (video backplane) 522. In one embodiment, the underlay content 500 is broadcast as a video signal along a channel 525. In one embodiment, the position and size of the underlay content 500 within a single video frame (e.g., a video image surrounded by “black” areas within a full video frame) is set (such as at the headend 104) prior to transmission, thus allowing the underlay content 500 to be placed in a fixed position on the graphical underlay 522. Performing scaling prior to transmission consumes less bandwidth, since the black areas (over which the interactive content page 527 is to be positioned) are easier to compress. As shown subsequently in FIG. 7A, in another embodiment, multiple underlay contents may also be transmitted from the headend 104 to the STB 102 and displayed on the graphical underlay 522.

In FIG. 5B, assume that an interactive content page 527 is loaded as a graphical overlay 520 on the television 202 screen. The interactive content page 527 may be loaded based upon an action of a user (e.g., by selection of a button on a remote control device 204 to load the content page 527) or by a user opting to allow automatic launching of the content page 527 by use of a triggering mechanism.

One implementation of the synthetic channels (interactive television pages) would be, for example, by way of the cable modem integrated into the STB 102. The cable modem receives the same RF signal as received by the tuner system 214 (FIG. 3). A splitter may be used to provide the RF signal to both tuner system 214 and modem. The cable modem provides a method for internet protocol (IP) packets to be transmitted between the STB 102 and the network 100. As an example, when a user hits a remote control device button to pull up a synthetic channel's “home page” such as the Shopping page, the STB 102 uses IP packets to send a request for the Shopping page upstream to the head-end 104. The request includes the URL of the Shopping page. A server at the headend 104 responds using IP packets to send the Shopping page downstream to the STB 102. The Shopping page is sent using hypertext markup language (HTML) or a protocol similar to HTML that is compatible with a display on televisions.

Other techniques can be used to obtain content for the interactive content page 527. The content can be obtained from a channel by tuning to that channel with an in-band tuner (such as the same tuner used to tune to a video channel). The content in that channel can be carousel broadcast, so as to allow the tuner to obtain the information when needed. The content for the interactive content page 527 may also be obtained from an out-of-band channel (such as that used for electronic program guide data), or from local storage like a PVR.

The interactive content page 527 has a transparent section 535 that shows a portion of the graphical underlay 522, and the underlay content 500 can be seen through the transparent section 535. It is noted that the transparent section 535 may vary in size and/or shape. For instance, the transparent section 535 does not have to visually appear as a rectangle. The transparent section 535 (and the video shown therein) can be L-shaped or made of portions that are not visually adjacent.

The interactive content page 527 is typically transmitted along a channel 532 from the headend 104 prior to being displayed on the television 202 screen. The underlay content 500 may be formatted/scaled to fit within the dimensions of the transparent section 535 and shown on its own channel 525. The display engine 410 may format/scale the underlay content 500 to fit within the transparent section 535 in one embodiment where the STB 102 has such processing capability, or the underlay content 500 may be formatted/scaled at the headend 104 to fit within the transparent section 535 prior to broadcast to STB 102 via channel 525 in other embodiments. The tuner system 214 tunes to the channel 532, and the interactive content page 527 is shown on the television 202 screen, and the tuner system 214 also tunes to the channel 525 so that the underlay content 500 is broadcast on the graphical underlay 522. For a single tuner STB, the underlay content 500 is typically shown after the interactive content page 527 is shown on the television 202 screen. In addition or alternatively, the tuner system 214 may also tune to a channel 529 that may broadcast other underlay content, or multiple underlay contents in a single composite video signal.

The underlay content 500 may be, for example, a broadcast video. Of course, the underlay content 500 may also be an image, picture, text, other information, or a combination of information. Other possible sources include a video-on-demand (VOD) server. In one embodiment, the video from a VOD can be synchronized with the user's actions. For instance, the video can be streamed from the VOD for presentation within the transparent section 535 in response to the user clicking a “See video” icon on the interactive content page 527 or in response to other user activity, thus allowing the video advertisement to start or stop as needed. As a variation to the VOD source, a PVR or other local storage can be the source of the video (which may have been previously downloaded into the PVR).

As an example in one implementation, the video signal of an underlay content 500 can be broadcast along a channel, such as a virtual channel, prior to displaying the underlay content 500 on the graphical underlay 522. Features and/or enhancements for implementing a virtual channel are of the type available from, for example, WINK COMMUNICATIONS, INC., 1001 Marina Village Parkway, Suite 100, Alameda, Calif. 94501.

In one embodiment, the display engine 410 (FIG. 4) permits the underlay content 500 to be shown after the interactive content page 527 is loaded on the television 202 screen. The display of the interactive content page 527 and the underlay content 500 are coordinated at, for example, the headend 104 so that when the user selects the interactive content page 527 to be displayed on the television 202 screen, then underlay content 500 is concurrently or subsequently shown through the transparent section 535.

For set top boxes with a single tuner (e.g., a DCT-2000 STB), the underlay content 500 is typically shown after the interactive content page 527 is downloaded to the set top box. The underlay content 500 may also be broadcast in a periodic or repeating manner, so that the viewer may see the underlay content 500 at least one time while viewing the interactive content page 527. Set top boxes with multiple tuners can be used in one embodiment to concurrently present multiple underlay content (from different video sources, including those recorded in a personal video recorder or PVR or other storage device) through one or more transparent sections.

Alternatively or in addition for STBs 102 having sufficient processing and storage capability, the display engine 410 may also display an underlay content 500 that is obtained from a suitable storage device such as the storage system 302. For example, the underlay content 500 may be downloaded from the headend 104, stored in the storage system 302 by the recording engine 435 (FIG. 4), displayed at a portion of the graphical underlay (video backplane) 522 by the display engine 410, and shown through the transparent section 535 of the interactive content page 527.

In one embodiment, the recording engine 435 (FIG. 4) may record content that is stored as recorded content 440. The recorded content 440 may be, for example, pre-recorded advertisement that is useful for advertisers in cable systems that do not provided dedicated broadcast channels for broadcasting advertisements for display through the transparent section 535.

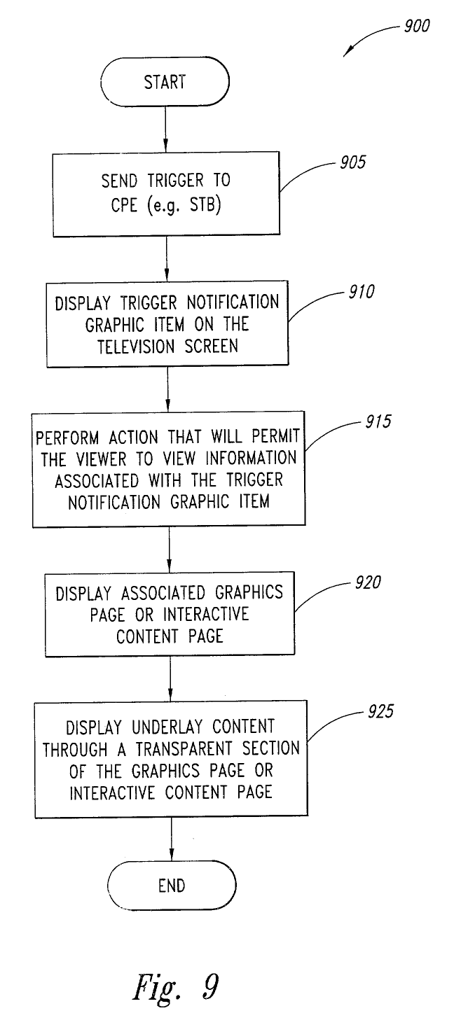

In another embodiment as shown in the method 900 in FIG. 9, when an ATVEF trigger (or other triggering mechanism) is sent or transmitted (905) to the STB 102 (or other customer premise equipment), an ATVEF notification graphic item (or other trigger-enabled graphic item) is displayed (910) on the television 202 screen. If the viewer decides to view the information associated with the ATVEF notification graphic item (or other trigger-enabled items), then the viewer may, for example, press (915) an acknowledgement button on the remote control device 204 or perform (915) other action that will permit the viewer to view the information associated with the graphic item. An associated graphics page (e.g., an interactive content page 527) may then be displayed (920) on the television 202 screen. An underlay content 500 that is related to the graphics page may then be displayed (925) through a transparent section 535 of the graphics page. Other types of triggering methods are provided by, for example, WINK COMMUNICATIONS, INC. of Alameda, Calif. and WORLDGATE, INC./THE INTERNET CENTRE, 4130-95 Street, Edmonton, Alberta, Canada, T6E 6H5. It is noted that a DCT-2000 type set top box typically does not support the ATVEF triggering feature.

As an example, the viewer may be watching the television 202 and tuned to a channel (e.g., Channel number “2”) and watching a program such as a Major League Baseball game. During the program, when a user makes a selection, a triggering mechanism (e.g., an ATVEF trigger) launches a graphics page that appears on the television screen. The tuner system 214 then tunes to a channel 525 (which may be, for example, channel “709”) that broadcasts a video related to graphics page. The video is displayed through the transparent section of the graphics page. When the user closes the graphics page, the tuner system 214 tunes back to channel number “2”. During this entire sequence, in one embodiment, the channel number displayed by the STB 102 (if STB 102 displays such channel numbers) is channel number “2”.

It is also noted that the use of triggers is not required in an embodiment of the invention. Typically, the user may select the interactive content, and the underlay content will appear in the transparent section of the graphical overlay at the current position of the underlay content in the broadcast stream being transmitted from the headend 104 to the STB 102.

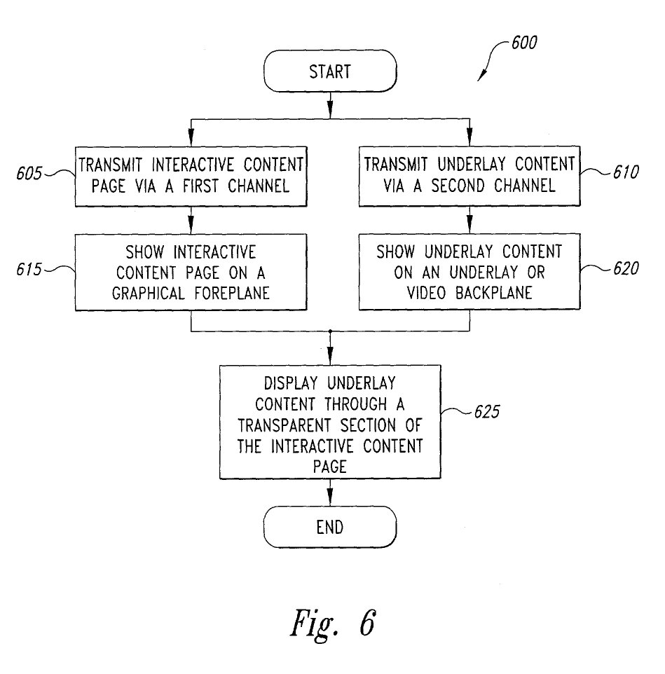

FIG. 6 is a flowchart showing a method 600 of advertising according to a specific embodiment of the invention. The method 600 may run continuously or at representative intervals. An interactive content page is transmitted (605) via a first channel, and underlay content is transmitted (610) via a second channel. The interactive content page is shown or loaded (615) on a graphical foreplane, and the underlay content is shown or loaded (620) on a graphical underlay (or video backplane). It is to be appreciated that the method 600 is not intended to necessarily and strictly represent the timing of the sequence of events. For instance, in one embodiment, the interactive content page 527 is transmitted and shown at 605 and 615, prior to transmission and presentation of the underlay content 500 at 610 and 620. This may occur, for instance, in implementations where a single tuner is being shared for both underlay and overlay content.

In another embodiment, the underlay content is stored in memory after being transmitted via the second channel and prior to being shown on the graphical underlay. As an example, the interactive content page may be shown on a screen of a display device such as the television 202. The underlay content may be, for example, a video (or another type of video enhancement) showing a commercial related to the interactive content page. The user/viewer may, for example, issue commands, via remote control device 204 (FIG. 2) to show the interactive content page, or the user can have the option of automatically launching the interactive content page based upon a triggering mechanism. The underlay content can then be displayed or viewed (625) through a transparent section of the interactive content page.

FIGS. 7A to 7F are block diagrams illustrating another operation of an embodiment of the invention. Referring first to FIG. 7A, multiple underlay contents 700, 705, 710, and 715 are transmitted from the headend 104 to the STB 102. The underlay contents 700 through 715 are displayed in separate areas of the graphical underlay 522. In one embodiment, the underlay contents 700 through 715 are broadcast in separate channels or in a single composite video 720 along a channel 725. The display engine 410 (FIG. 4), which may have graphics processing capability, processes the single composite video 720. In one embodiment, the single composite video 720 is a broadcast television signal that is capable of handling multiple video images that are composited into a single graphical underlay 522 that can be used by multiple different overlays to provide excellent video in limited bandwidth/capability STBs. The display engine 410 (FIG. 4) can translate the position of each underlay content or the position can be fixed at a headend prior to transmission, thus allowing the multiple underlay contents 700 through 715 to be broadcast along the single broadcast channel 725 and placed in a fixed position on the graphical underlay 522. It is noted that the number of underlay contents shown in FIG. 7A may vary in number and size, and the position of the underlay contents on the graphical underlay 522 may also vary.

By broadcasting multiple underlay contents along the single channel 725, the multiple underlay contents may be prevented from having multiple audio streams. However, in another embodiment, the multiple underlay contents 700 through 715 are broadcast along separate channels or from a local storage device. This method allows each of the underlay contents to have an associated unique audio signal that can be heard by the user. This method also typically does not require any more bandwidth except for the small additional bandwidth requirement for the audio signal. The various channels or sources can be sequentially tuned to one after another by a single tuner, or concurrently tuned to by multiple tuners.

In FIG. 7B, assume that an interactive content page (A) 730 is loaded as a graphical overlay 520 on the television 202 screen. The interactive content page (A) 730 has a transparent section 735a that shows a portion of the graphical underlay 522. The underlay content 700 can be seen through the transparent section 735a. As similarly described above, in one embodiment, the underlay content 700 may be shown after the interactive content page (A) 730 is loaded on the television 202 screen. The underlay content 700 may be broadcast in a periodic or repeating manner to permit the user/viewer to see the entire underlay content 700 at least once. In addition or alternatively, the tuner system 214 may also tune to a channel 737 which may broadcast other underlay content or multiple underlay contents in a single composite video signal.

Similarly, FIG. 7C shows the interactive page (B) 740 as being loaded as an overlay 520. The underlay content 705 can be seen through the transparent section 735b of interactive content page (B) 740.

Similarly, FIG. 7D shows the interactive page (C) 745 as being loaded as an overlay 520. The underlay content 710 can be seen through the transparent section 735c of interactive content page (C) 745.

Similarly, FIG. 7E shows the interactive page (D) 750 as being loaded as an overlay 520. The underlay content 715 can be seen through the transparent section 735d of interactive content page (D) 750.

In another embodiment, an interactive content page may have more than one transparent section. For example, as shown in FIG. 7F, an interactive content page (E) 755 has the transparent sections 735c and 735d for showing the underlay content 710 and underlay content 715, respectively. The number and sizes of the transparent sections in the interactive content page (E) 755 may vary.

As an example, interactive content page (A) 730 may be a graphics page for sports. Therefore, the underlay content 700 may be a sports advertisement. As another example, the interactive content page (B) 740 may be a graphics page related to finance. Therefore, the underlay content 705 may be an advertisement on finance or money matters. Similarly, the interactive content pages 745, 750, and 755 may relate to similar or other topics.

The various transparent sections in the interactive content pages may also be useful for giving the user/viewer/consumer a choice to view different commercials in the underlay contents. For example, assume that the multiple interactive content pages 730 through 755 relate to a particular car manufacturer (e.g., GENERAL MOTORS) and that each interactive content page relates to a different GM vehicle. For example, interactive content pages 730, 740, 745, and 750 may be related to SUVs, trucks, sedans, and sport coupes, respectively. If the viewer prefers SUVs, then he/she can select the interactive content page 730 and view the underlay content 700 which may be, for example, a video commercial on a particular SUV. Thus, in this specific example, there may be four different versions of the interactive content pages, and each interactive content page will show a particular underlay content that is, for example, a video commercial for a particular type of vehicle.

In another embodiment, the display engine 410 can determine the particular channel(s) to tune based upon the particular type of graphical overlay. For example, if the interactive television content page on the graphical overlay is designed by digeo, inc. of Kirkland, Washington, then the display engine 410 (along with tuner system 214) may select one or more hidden channels (assigned to digeo, inc.) to show in the transparent section the underlay contents that are broadcast from those hidden channels.

In an embodiment, each piece of video content can be described by a shape, a position, a size, and some unique identifier. The unique identifier can map to a channel and a time (or multiple times). Alternatively or in addition, the time component can be removed by assuming that a single video appears constantly on a single channel.

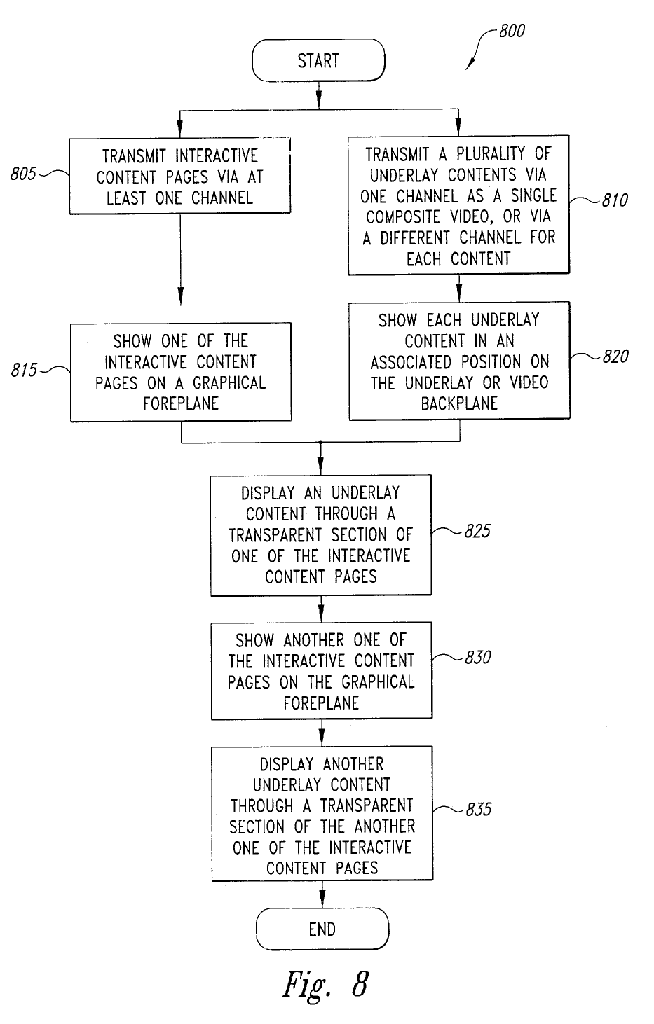

FIG. 8 is a flowchart illustrating an advertising method 800 according to another embodiment of the invention. The method 800 may run continuously or at representative intervals. A plurality of interactive content pages are transmitted (805) via at least one channel, and a plurality of underlay contents are transmitted (810) as a single composite video via another channel. In another embodiment, the underlay contents are each transmitted (810) via different channels. It is to be appreciated that the method 800 is not intended to necessarily and strictly represent the timing of the sequence of events. For instance, in one embodiment, the interactive content page 527 is transmitted and shown at 805 and 815, prior to transmission and presentation of the underlay content 500 at 810 and 820. This may occur, for instance, in implementations where a single tuner is being shared for both underlay and overlay content.

One of the interactive content pages is shown or loaded (815) on a graphical foreplane, and each of the underlay contents is shown or loaded (820) in an associated position on a graphical underlay (or video backplane). An underlay content can then be displayed or viewed (825) through a transparent section of the interactive content page. Another one of the interactive content pages may then be shown (830) on the graphical foreplane. Another one of the underlay contents can then be displayed or viewed (835) through a transparent section of the another one of the interactive content pages.

As previously described above, FIG. 9 is a flowchart of a method 900 for displaying underlay content through a transparent section of an interactive content page. The interactive page is shown to the user if the user selects an associated trigger notification item on a television screen.

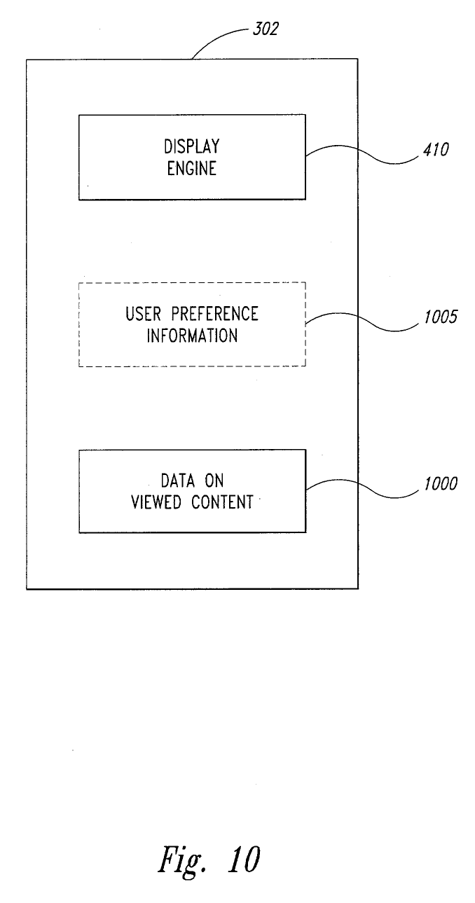

FIG. 10 is a block diagram of other various applications that may be stored in a storage device (e.g., storage system 302). As described below, the display engine 410 can be configured to alternatively or additionally perform at least some functions as described below. In addition, the controller 310 can track data 1000 indicating if a particular underlay content has been shown to a user, as discussed below. In another embodiment, the controller 310 may track user preference data (information) 1005 that can be stored in, for example, storage system 302 or at an upstream stage (e.g., at the headend 104).

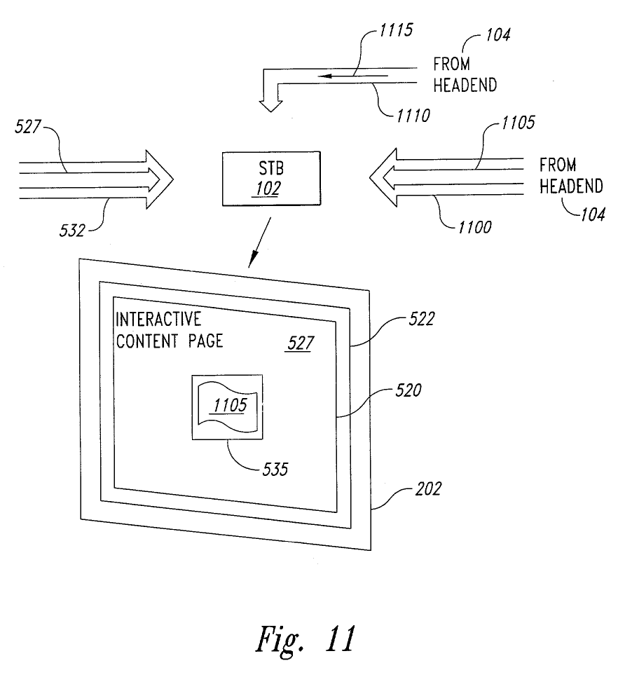

FIG. 11 is a block diagram illustrating the sequencing of underlay contents according to an embodiment of the invention. Assume that an interactive content page 527 is loaded as a graphical overlay 520 on the television 202 screen (or other suitable display device). The interactive content page 527 may be loaded based upon an action of a user (e.g., by selection of a button on a remote control device 204) or by a user opting to allow automatic launching of the content page 527 by use of a triggering mechanism or via some user-initiated action. As similarly stated above, the interactive content page 527 is typically transmitted along a channel 532 from the headend 104 prior to being displayed on the television 202 screen. A channel 1100 also broadcasts underlay content 1105 from headend 104. When the tuner system 214 tunes to the channel 532, the interactive content page 527 is shown on the television 202 screen, and the tuner system 214 then subsequently tunes to the channel 1100 so that the underlay content 1105 is broadcast on the graphical underlay 522 and shown through the transparent section 535.

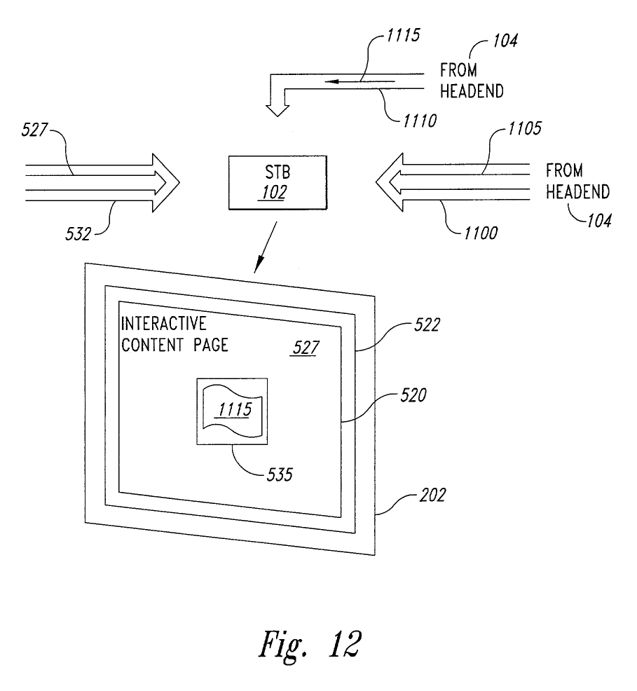

In one embodiment, multiple underlay contents can be shown through the transparent section 535 based on the following method. As stated above, assume that the underlay content 1105 is first shown to the viewer through the transparent section 535 in the interactive content page 527. After the entirety of the programming content of underlay content 1105 is shown, the tuner system 214 then tunes to channel 1110 that is broadcasting an underlay content 1115. As a result, the underlay content 1115 will be shown through the transparent section 535, as shown in FIG. 12. As a result, the underlay contents 1105 and 1115 are shown in sequence through the transparent section 535.

At least another additional channel (not shown) may be provided for broadcasting underlay content from the headend 104 (or other broadcast center or upstream stage) to the set top box 102 (or other customer premise equipment). The tuner system 214 can sequentially tune to the additional channel(s) to show the broadcasting underlay content through the transparent section 535. As a result, a variable number of underlay contents may be shown in a sequential manner through the transparent section 535 of the interactive content page 527.

One method for signaling the tuner system 214 to tune from one channel (e.g., channel 1100) to another channel (e.g., channel 1110) is as follows. When the controller 310 or other component in the set top box 102 detects the end of the programming content (e.g., end of the commercial video) in the underlay content 1105, then the controller 310 can signal the tuner system 214 to tune to the channel 1110 to permit the subsequent showing of the underlay content 1115 through the transparent section 535. An end (or demarcation) of the programming content in an underlay content may be determined by, for example, the controller 310 detecting for triggers at the demarcation points in the programming content. Triggers may be present to demarcate both beginning and end points of a video clip, in one embodiment. The ending point trigger can be used to initiate a channel change to bring a new video into view, while a beginning point trigger can be used to ensure that the viewer has seen the entire clip. For example, a clip can be considered to have been “fully viewed” if a beginning point trigger followed by an ending point trigger has been detected.

In another embodiment, the display engine 410 (or other component) can track each underlay content that is shown through the transparent section 535. For instance, in an embodiment where each piece of video content is described by a shape, a position, a size, and some unique identifier mapped to a channel and a time (or multiple times), tracking which content has been seen can be trivial when each piece of video content has been mapped to a single channel, since the channel number itself becomes the unique identifier. For embodiments where multiple video clips are transmitted in a single channel, each video clip can be virtualized to a virtual channel. For example, if there are four video clips in channel 888, the video clips can be treated as 888-1, 888-2, 888-3, and 888-4 (virtual channel numbers). The display engine 410 or other component can monitor and know which virtual channel is actually being displayed.

The data indicating the previously shown underlay content(s) is illustrated as data 1000 in FIG. 10. As an example, assume that the viewer loads the interactive content page 527 on the television screen. The underlay content 1105 will then be shown to the viewer via transparent section 535. The display engine 410 then detects that the underlay content 1105 has been shown via transparent section 535. If a viewer closes the interactive content page 527, then data 1000 will indicate that underlay content 1105 has previously been shown through the transparent section 535 (via the identification techniques described above). When the viewer again loads the interactive content page 527 on the television screen, then the display engine 410 will signal the tuner 214 to tune to the channel 1110 in order to broadcast the not-yet-viewed underlay content 1115 via transparent section 535.

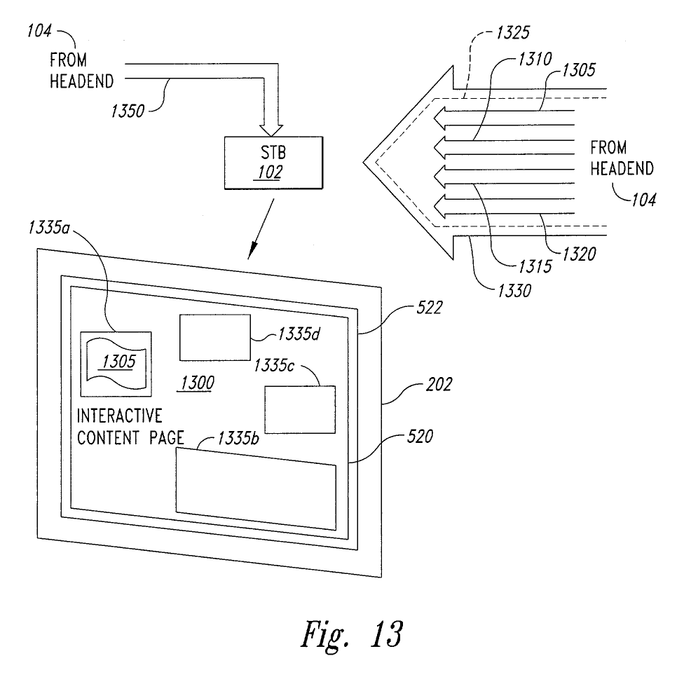

FIG. 13 is a block diagram illustrating the sequencing of underlay contents according to another embodiment of the invention. Assume that an interactive content page 1300 is loaded as a graphical overlay 520 on the television 202 screen (or other suitable display device). The interactive content page 1300 may be loaded based upon an action of a user (e.g., by selection of a button on a remote control device 204) or by a user opting to allow automatic launching of the content page 1300 by use of a triggering mechanism or via some other user-initiated action. As similarly stated above, the interactive content page 1300 is typically transmitted along a channel (e.g., channel 532 in FIG. 12) from the headend 104 prior to being displayed on the television 202 screen.

Assume that underlay contents 1305, 1310, 1315, 1320 are transmitted from the headend 104 to the STB 102 via separate channels or in a single composite video 1325 along a channel 1330. The number of underlay contents in the video 1325 may vary. In one embodiment, the underlay contents 1305 through 1320 are displayed in separate areas of the graphical underlay 522.

When the tuner system 214 tunes to the channel 532, the interactive content page 1300 is shown on the television 202 screen. Assume that the interactive content page 1300 includes multiple transparent sections 1335a, 1335b, 1335c, and 1335d. The number of transparent sections in the interactive content page 1300 may vary. The sequencing of underlay contents is as follows. The underlay content 1305 may first be shown via transparent section 1335a. In one embodiment, the display engine 410 substantially blocks the underlay contents 1310, 1315, and 1320 from view through transparent sections 1335b, 1335c, and 1335d, respectively. For example, an opaque image cover may be placed by display engine 410 over the transparent sections 1335b, 1335c, and 1335d, and, therefore, underlay contents are substantially prevented from being seen through these blocked transparent sections 1335b, 1335c, and 1335d. In an embodiment, pixel alpha blending techniques can be used to control the degree of transparency through the transparent sections.

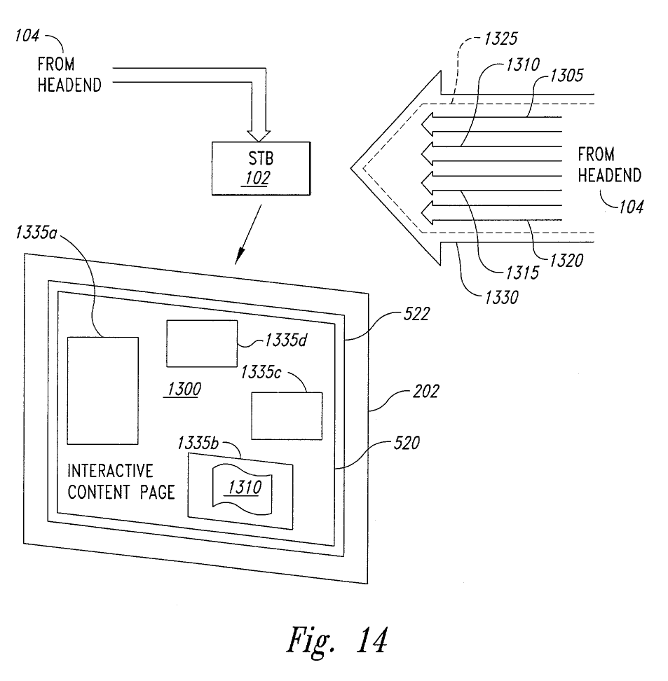

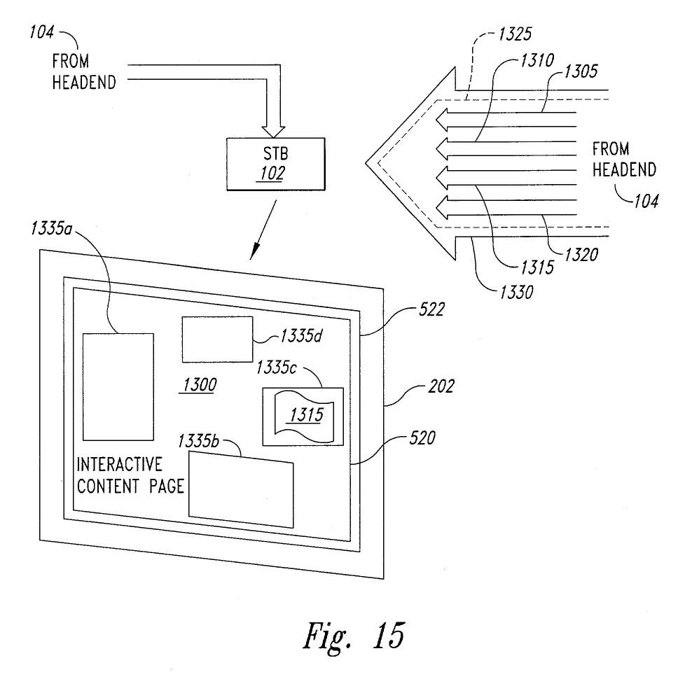

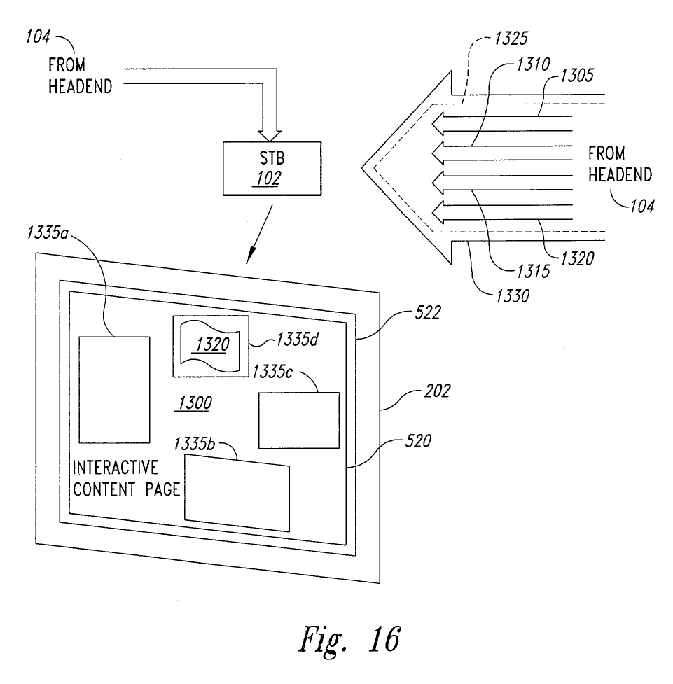

As shown in FIG. 14, when the display engine 410 detects a trigger that indicates an end of the program content for underlay content 1305, the display engine 410 will subsequently block the underlay content 1305 from view via transparent section 1335a. The display engine 410 will permit the viewing of, for example, the underlay content 1310 via transparent section 1335b. The display engine 410 continues to block the underlay contents 1315 and 1320 from view through transparent sections 1335c and 1335d, respectively. The process repeats to present the subsequent underlay contents 1315 and 1320, as depicted in FIG. 15 and FIG. 16, respectively.

Thus, as shown in the example of FIGS. 13 through 16, different underlay contents may be shown through the transparent sections 1335a through 1335d in a sequential manner (or carousel like movement). It is noted that the underlay contents may be shown in other sequential orders. For example, the underlay contents may be shown in the following sequential order: underlay content 1320 via transparent section 1335d, underlay content 1305 via transparent section 1335a, underlay content 1310 via transparent section 1335b, and underlay content 1315 via transparent section 1335c. Other different sequential orders may be possible, including concurrent presentation in embodiments that use multiple tuners.

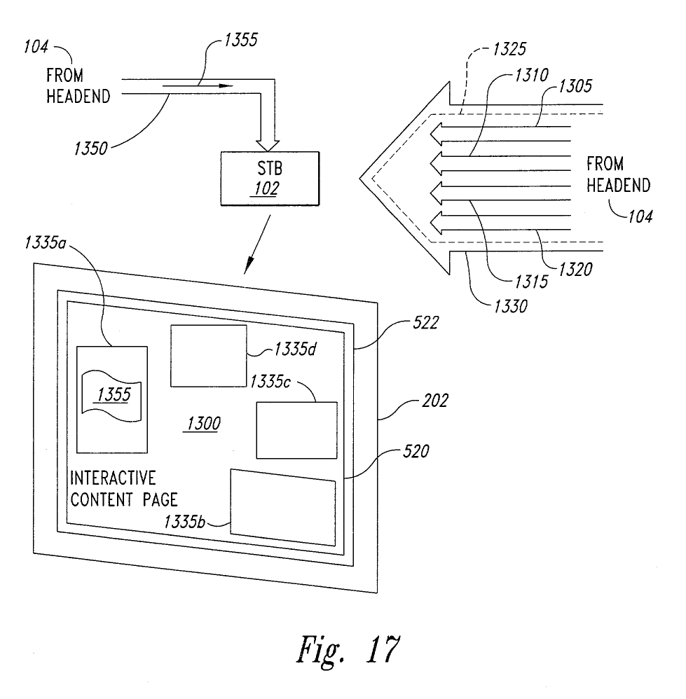

Referring now to FIG. 17, assume that another channel 1350 broadcasts underlay content 1355 from the headend 104 to the set top box 102. As an example, assume that the display engine 410 detects a trigger that indicates an end of the program content for underlay content 1320 (FIG. 16). After the entirety of the programming content of underlay content 1320 is shown transparent section 1335d, the tuner system 214 then tunes to the channel 1350 that is broadcasting underlay content 1355. As a result, the underlay content 1355 will be shown through a transparent section (e.g., transparent section 1335a). Therefore, the underlay content 1320 (FIG. 16) and underlay content 1355 are shown in sequence. Techniques similar to those described above with reference to FIGS. 11-12 can be used to determine which video clips have been previously shown, for the examples of FIG. 13-16 and FIG. 17.

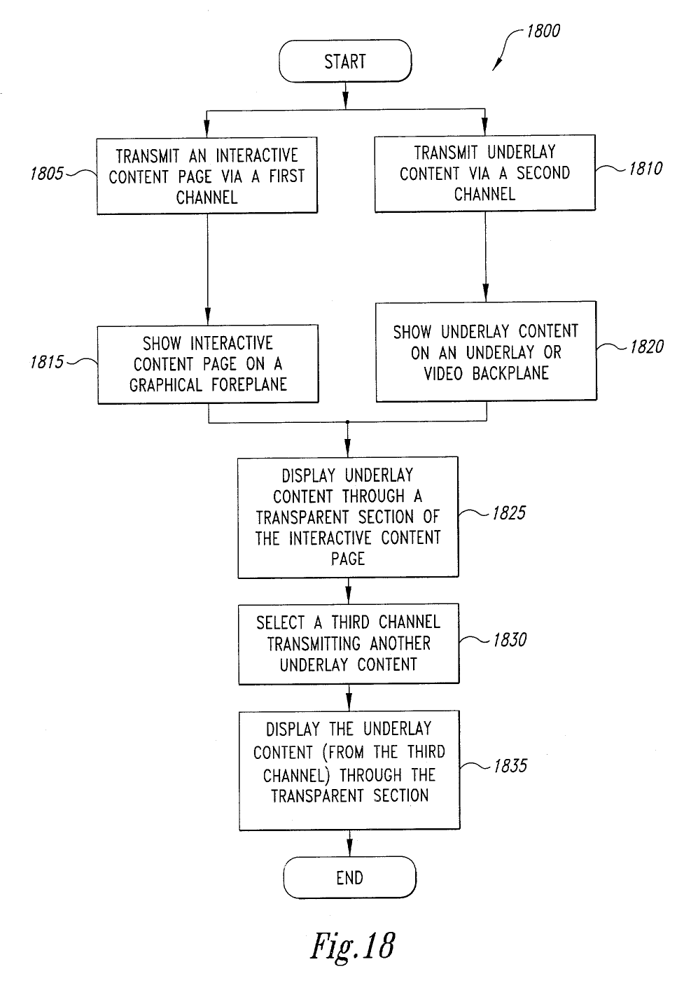

FIG. 18 is a flowchart of a method 1800 for displaying underlay contents in a sequential manner according to a specific embodiment of the invention. The method 1800 may run continuously or at representative intervals, and it is understood that any of the underlay content shown in FIG. 18 may be displayed after its corresponding interactive content page has been loaded and shown. An interactive content page is transmitted (1805) via a first channel, and an underlay content is transmitted (1810) via a second channel. The interactive content page is shown or loaded (1815) on a graphical foreplane, and the underlay content is shown or loaded (1820) on a graphical underlay (or video backplane). In another embodiment, the underlay content is stored in memory after being transmitted via the second channel and prior to being shown on the graphical underlay. As an example, the interactive content page may be shown on a screen of a display device such as the television 202. The underlay content can then be displayed or viewed (1825) through a transparent section of the interactive content page. A third channel that is transmitting another underlay content is then tuned or selected (1830). The underlay content (from the third channel) is then displayed (1835) through the transparent section. Thus, multiple underlay content may be shown via a transparent section in a sequential manner.

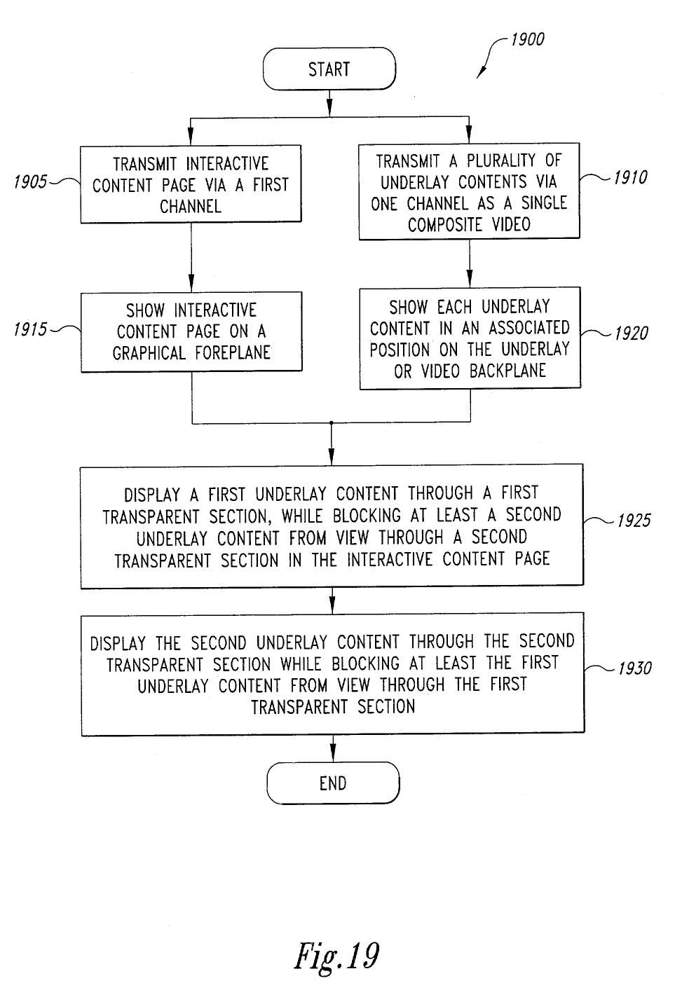

FIG. 19 is a flowchart of a method 1900 for displaying underlay contents in a sequential manner according to another specific embodiment of the invention. The method 1900 may run continuously or at representative intervals, and it is understood that any of the underlay content of FIG. 19 may be displayed after its corresponding interactive content page has been loaded and displayed. An interactive content page (with a plurality of transparent sections) is transmitted (1905) via at least one channel, and a plurality of underlay contents are transmitted (1910) as a single composite video via another channel. In another embodiment, the underlay contents are each transmitted (1910) via different channels.

The interactive content page is shown or loaded (1915) on a graphical foreplane, and each of the underlay contents is shown or loaded (1920) in an associated position on a graphical underlay (or video backplane). A first underlay content is displayed or viewed (1925) through a first transparent section of the interactive content page, while at least a second underlay content is substantially blocked from view through a second transparent section of the interactive content page. The second underlay content is then displayed or viewed (1930) through the second transparent section of the interactive content page, while at least the first underlay content is substantially blocked from view through the first transparent section of the interactive content page.

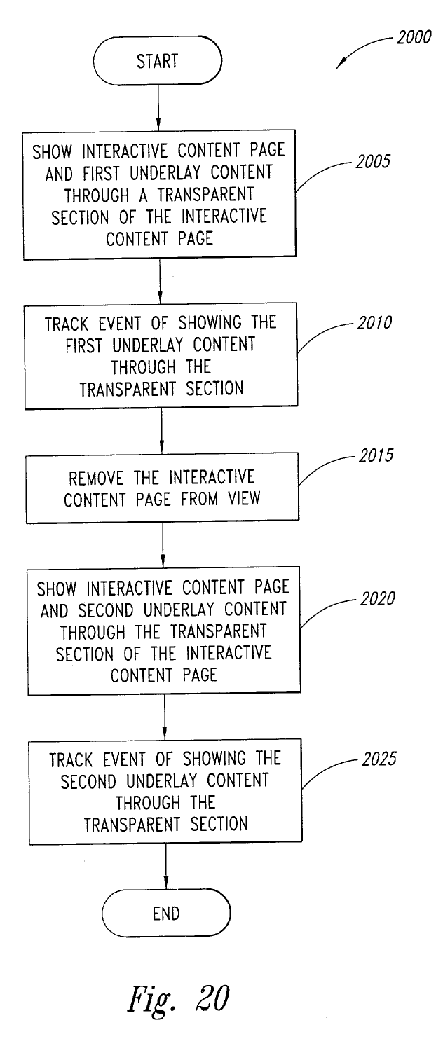

FIG. 20 is a flowchart of a method 1900 for displaying underlay contents in a sequential manner according to another specific embodiment of the invention. The method 2000 may run continuously or at representative intervals. An interactive content page is shown (2005) on, for example, a display device screen, while a first underlay content is shown through a transparent section of the interactive content page. The event of showing the first underlay content through the transparent section is then tracked (2010). The interactive content page may then be removed from view (2015). For example, the viewer may load another interactive content page relating to a different topic (e.g., the user may switch from the finance interactive content page to the sports interactive content page). As another example, the viewer may remove the interactive content page from the screen or turn off the display device.

The interactive content page may then again be shown (2020) on the display device screen, while a second underlay content is shown through the transparent section of the interactive content page. The event of showing the second underlay content through the transparent section is then tracked (2025). Another not-yet-shown subsequent underlay content may then be subsequently shown through the transparent section and the event of showing the subsequent underlay content is then tracked.

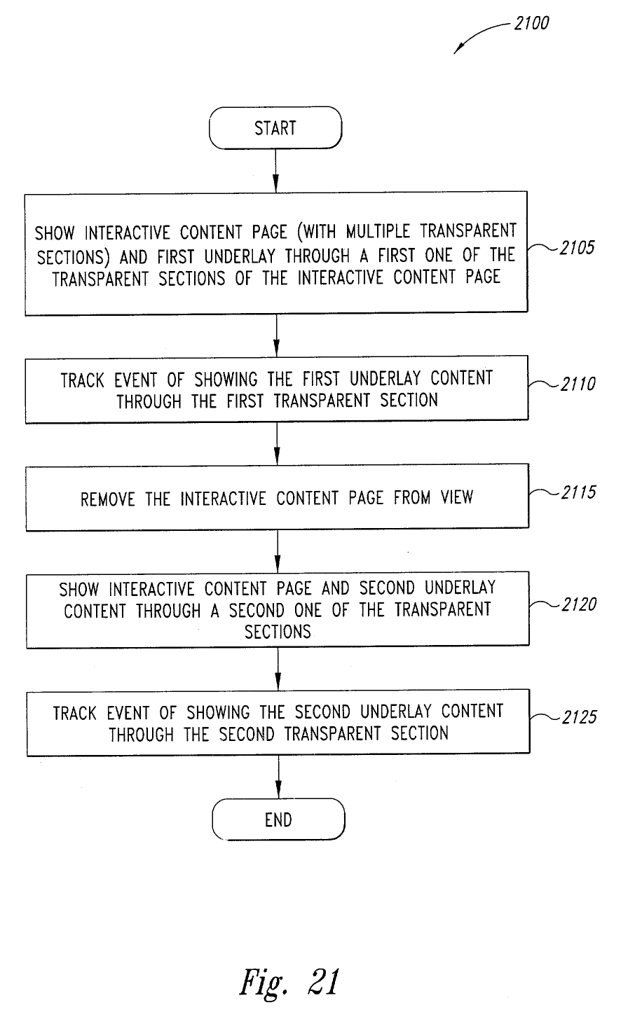

FIG. 21 is a flowchart of a method 2100 for displaying underlay contents in a sequential manner according to another specific embodiment of the invention, where the interactive content page may have multiple transparent sections. The method 2100 may run continuously or at representative intervals. An interactive content page (with multiple transparent sections) is shown (2105) on, for example, a display device screen, while a first underlay content is shown through a first one of the transparent sections of the interactive content page. The event of showing the first underlay content through the first transparent section is then tracked (2110). The interactive content page may then be removed from view (2115). For example, the viewer may load another interactive content page relating to a different topic (e.g., the user may switch from the finance interactive content page to the sports interactive content page). As another example, the viewer may remove the interactive content page from the screen or turn off the display device.

The interactive content page may then again be shown (2120) on the display device screen, while a second underlay content is shown through a second one of the transparent sections of the interactive content page. The event of showing the second underlay content through the second transparent section is then tracked (2125). Another not-yet-shown subsequent underlay content may then be subsequently shown through a transparent section and the event of showing the subsequent underlay content is then tracked.

In another embodiment of the invention, data 1005 (FIG. 10) relating to a preference of the viewer (user) may be tracked. In one embodiment, this data 1005 is stored in a local storage device such as storage system 302 (FIG. 10) or other memory devices configured in or coupled to the STB 102. Storing the data 1005 in a local storage device is useful in some implementations, such as the DCT-2000-type set top boxes that use dial-up access and are not continuously connected to a headend 104.

In another embodiment, user-preference data 1005 may be stored in a headend 104 or other upstream stages. Data 1005 that is stored upstream may be transmitted to the set top box at the same time that a trigger (e.g., ATVEF trigger) occurs. Thus, the manner of storing the user-preference data 1005 may depend on the particular type of connection that exists between a set top box and the headend 104.

The controller 310 (FIG. 3) or other component may track the user-preference data 1005 based upon, for example, the activities (actions) of a user of the set top box or based upon input data requested from a user of the set top box. The controller 310 may store the user-preference data 1005 in the local storage device or transmit the user-preference data 1005 to the headend 104 for storage in an upstream storage device.

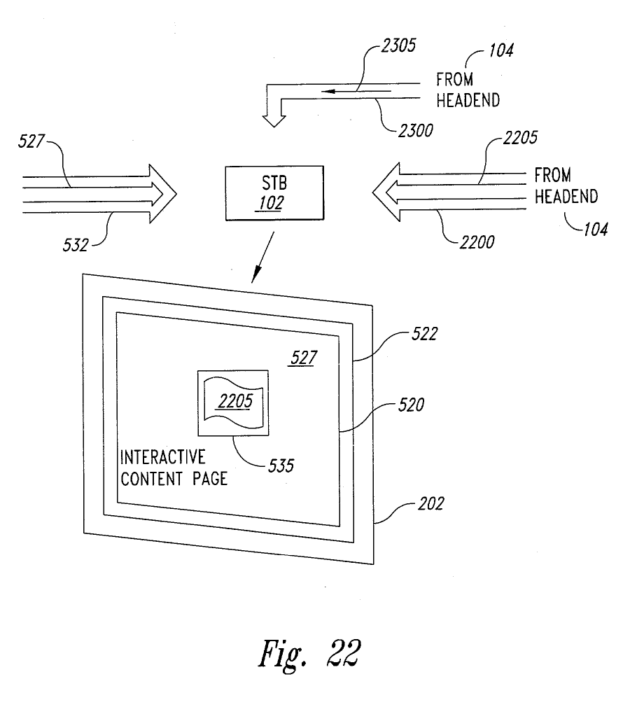

FIG. 22 is a block diagram illustrating the showing of underlay content based on user preference data (information), in accordance with an embodiment of the invention. Thus, underlay contents (such as video advertisements) that are shown through a transparent section may be personalized (or targeted) for the particular user/viewer. Stored user-preference data may be used to target video advertisements to the user, via correlation of the user-preference data with video clips available from channels, a VOD server, downloaded into local storage, or some other video source.

Assume that an interactive content page 527 is loaded as a graphical overlay 520 on the television 202 screen (or other suitable display device). The interactive content page 527 may be loaded based upon an action of a user (e.g., by selection of a button on a remote control device 204) or by a user opting to allow automatic launching of the content page 527 by use of a triggering mechanism or via some other user-initiated activity. As similarly stated above, the interactive content page 527 is typically transmitted along a channel 532 from the headend 104 prior to being displayed on the television 202 screen.

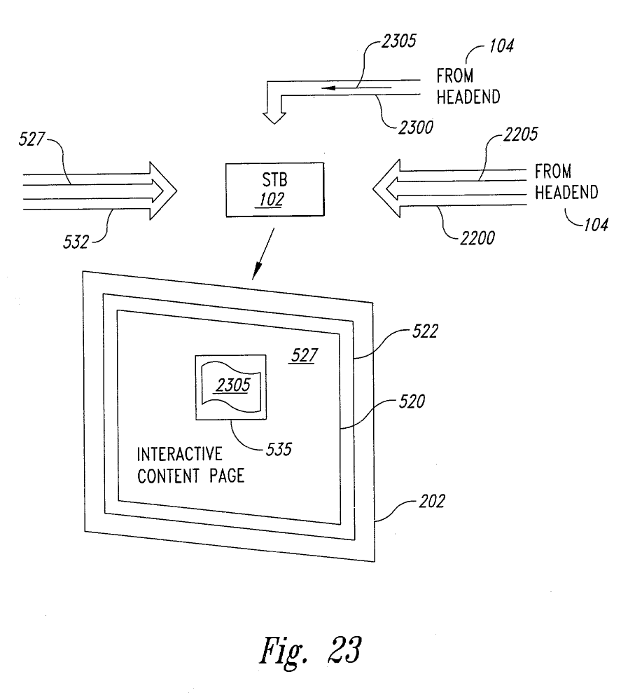

A channel 2200 also broadcasts underlay content 2205 from the headend 104 (or other broadcast center). When the tuner system 214 tunes to the channel 532, the interactive content page 527 is shown on the television 202 screen. When a triggering event occurs, the controller 310 can determine the user preference information 1005. Based on the user preference information 1005, the tuner system 214 then tunes to the channel 2200 so that the underlay content 2205 is broadcast on the graphical underlay 522 and shown through the transparent section 535 if the underlay content 2205 is related to the user preference information 1005. The controller 310 can determine if an underlay content is related to the user preference information 1005 by, for example, comparing identifiers or triggers in the underlay content with the user preference information. FIG. 23 illustrates that subsequent video clip(s) from another channel 2300 can be sequentially tuned to and displayed as underlay content 2305 through the transparent section 535, based on the user preference information 1005.

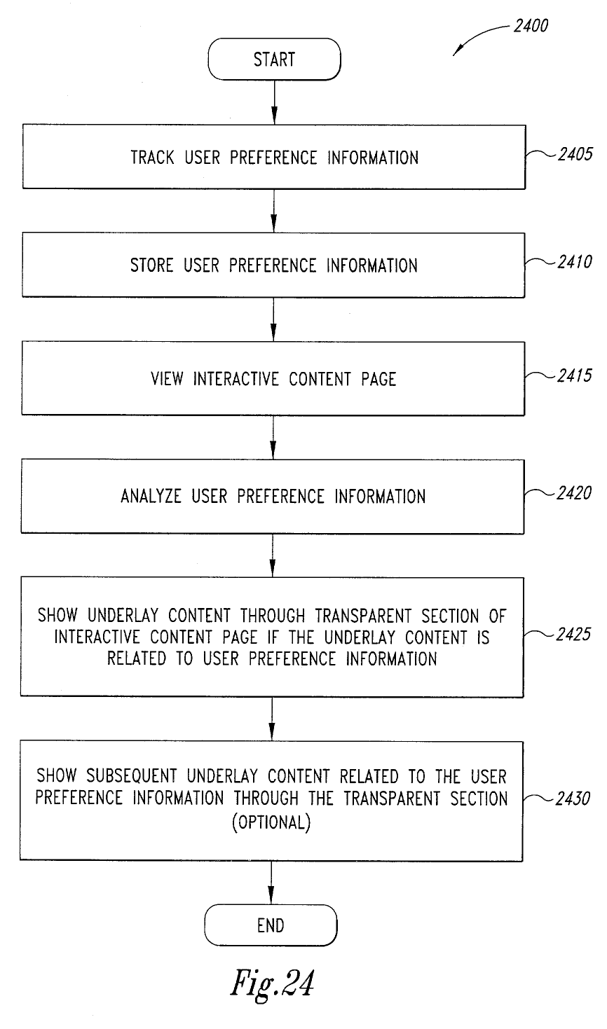

FIG. 24 is a flowchart illustrating a method 2400 of showing underlay contents based on user preference information, in accordance with an embodiment of the invention. User preference information is first tracked (2405) based on, for example, user activity or user provided information. The user preference information may be stored (2410) in, for example, an upstream stage, such as a storage device in a headend, or a local storage device such as a memory in a set top box. The user can view (2415) an interactive content page. User preference information is determined (analyzed) (2420), and an underlay content may be shown (2425) through a transparent section of the interactive content page if the underlay content is related to the user preference information. A subsequent underlay content may then be optionally shown (2430) through the transparent section if the subsequent underlay content is related to the user preference information. As a result, underlay contents may be shown through the transparent section in a sequential manner.

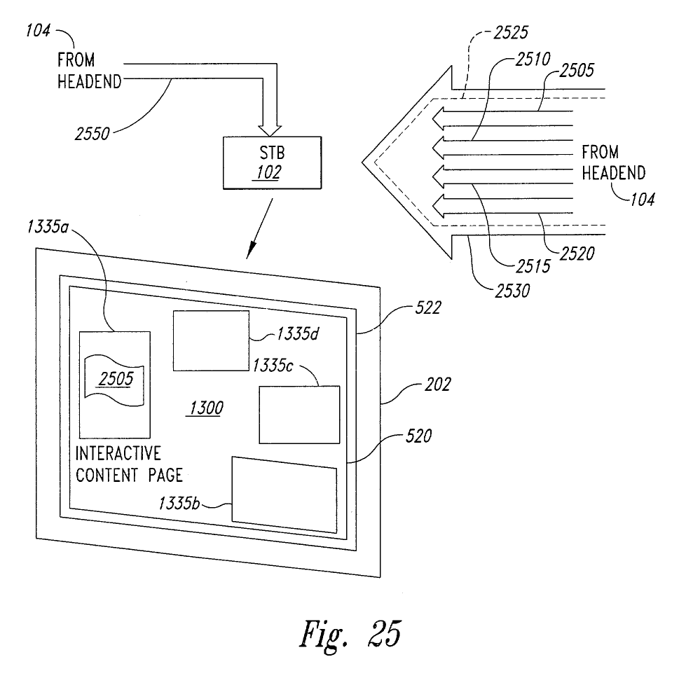

FIGS. 25-27 are a block diagrams illustrating the showing of underlay contents based on user preference information 1005, in accordance with another embodiment of the invention. Assume that an interactive content page 1300 is loaded as a graphical overlay 520 on the television 202 screen (or other suitable display device). The interactive content page 1300 may be loaded based upon an action of a user (e.g., by selection of a button on a remote control device 204) or by a user opting to allow automatic launching of the content page 1300 by use of a triggering mechanism or via some other user-initiated activity. As similarly stated above, the interactive content page 1300 is typically transmitted along a channel (e.g., channel 532) from the headend 104 prior to being displayed on the television 202 screen.

Assume that underlay contents 2505, 2510, 2515, and 2520 are transmitted from the headend 104 to the STB 102 in separate channels or in a single composite video 2525 along a channel 2530. The number of underlay contents may vary. In one embodiment, the underlay contents 2505 through 2520 are displayed in separate areas of the graphical underlay 522. Capability to move the position of the video around the display screen can be provided by some set top boxes. For example, two different interactive content pages may be both configured to show the same video clip. In one content page, the transparent section for the video clip is in the top left corner, and in the other content page, the transparent section for the video clip is in the lower right corner. If the set top box is not capable of supporting dynamic positioning of the video clip, the video clip is transmitted via two channels (or via a single channel with the same video clip in both of the requisite corners). If the set top box can dynamically position the video stream, then only a single channel of video is needed.

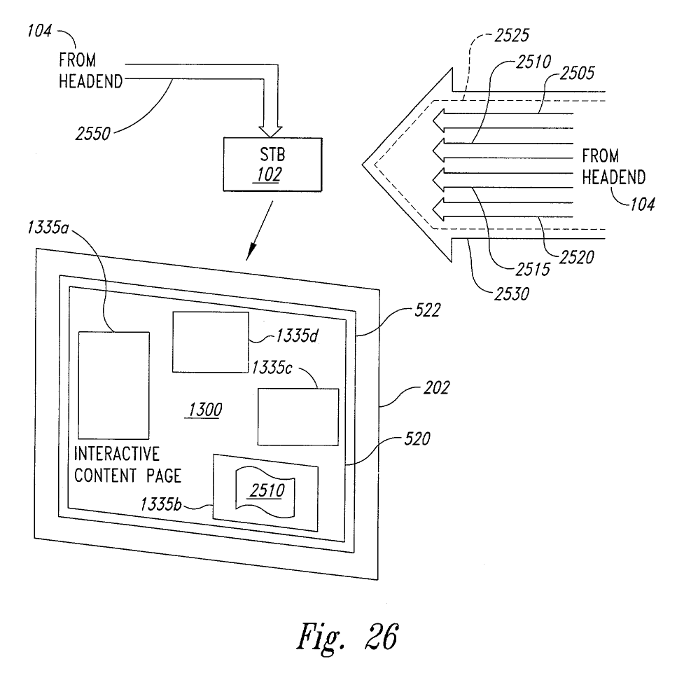

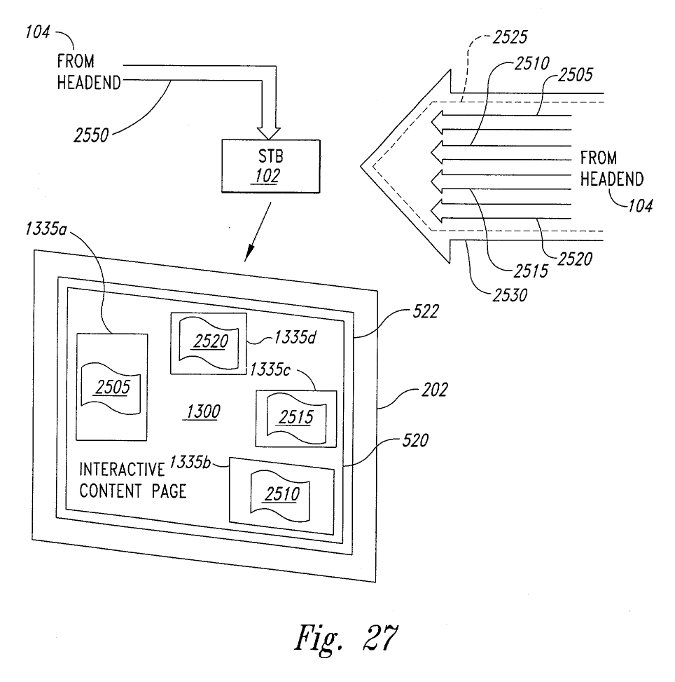

When the tuner system 214 tunes to an interactive content channel, the interactive content page 1300 is shown on the television 202 screen. Assume that the interactive content page 1300 includes multiple transparent sections 1335a, 1335b, 1335c, and 1335d. The number of transparent sections in the interactive content page 1300 may vary. The underlay content 2505 may first be shown via transparent section 1335a if the controller 310 determines that the underlay content 2505 is related to the user preference information 1005. In one embodiment, the display engine 410 blocks the underlay contents 2510, 2515, and 2520 from view through transparent sections 1335b, 1335c, and 1335d, respectively. For example, an opaque image cover may be placed by display engine 410 over the transparent sections 1335b, 1335c, and 1335d, and, therefore, underlay contents are prevented from being seen through these blocked transparent sections. As shown in FIG. 26, the process repeats to display the other underlay content in the other transparent sections, including the underlay content 2510 in the transparent section 1335b, based on the user preference information 1005. As shown in FIG. 27, at least some of the underlay content may be shown concurrently via use of multiple tuners, for a situation such as where the user preference of the viewer indicates an interest in sports utility vehicles, and so the interactive content page 1300 (and the video clips shown through its transparent sections) are tailored to the viewer's interests. Some of the underlay content may be obtained from a separate channel 2550.

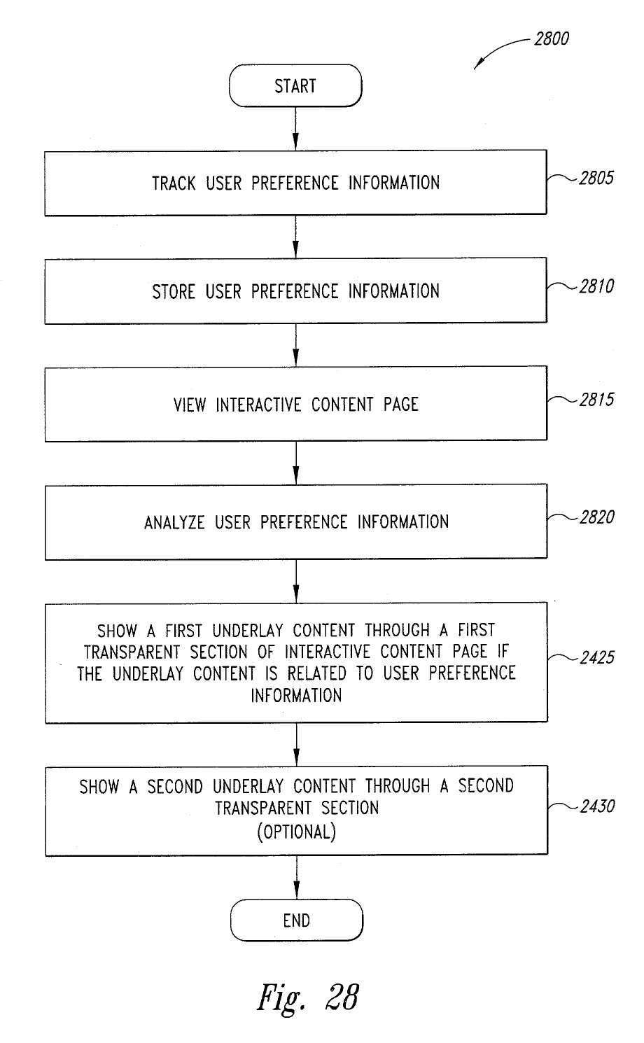

FIG. 28 is a flowchart illustrating a method 2800 of showing underlay contents based on user preference information, in accordance with another embodiment of the invention. User preference information is first tracked (2805) based on, for example, user activity or user provided information. The user preference information may be stored (2810) in, for example, an upstream stage, such as a storage device in a headend, or a local storage device such as a memory in a set top box. The user can view (2815) an interactive content page. User preference information is determined (analyzed) (2820), and a first underlay content may be shown (2825) through a first transparent section of the interactive content page if the underlay content is related to the user preference information. A second underlay content may then be optionally shown (2830) through a second transparent section. The second underlay content may or may not be related to the user preference information. As a result, underlay contents may be shown through the transparent sections in a sequential manner.

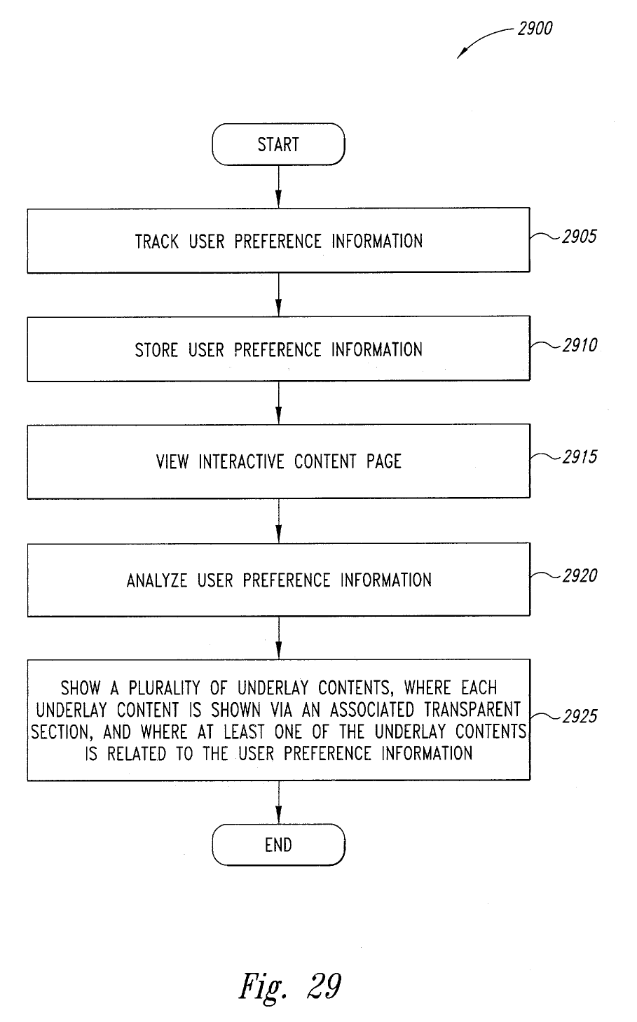

FIG. 29 is a flowchart illustrating the showing of underlay contents based on user preference information, in accordance with another embodiment of the invention. User preference information is first tracked (2905) based on, for example, user activity or user provided information. The user preference information may be stored (2910) in, for example, an upstream stage, such as a storage device in a headend, or a local storage device such as a memory in a set top box. The user can view (2915) an interactive content page. User preference information is determined (analyzed) (2920). A plurality of underlay contents may be shown (2925), where each underlay content is shown via an associated transparent section in the interactive content page, and where at least one of the underlay contents is related to the user preference information.

Other variations and modifications of the above-described embodiments and methods are possible in light of the foregoing teaching.

Further, at least some of the components of this invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For example, underlying video content can be shown through a translucent overlay in one embodiment, instead of or in addition to being shown through transparent sections 535 (or in any of the other depicted transparent sections) of the interactive content page(s). In such an embodiment, portions of the interactive content page can be a translucent overlay over the video (which may be in full screen). Portions of the underlying video frame may be “blacked out” or otherwise formatted to allow overlay content to be superimposed over non-video areas. Meanwhile, the relevant video content is shown through translucent regions of the interactive content page 527. In FIG. 5B, for example, the underlay content 500 can be presented through a translucent section 535.

Different shapes, sizes, and locations of the translucent sections of the interactive content page can be provided. In one embodiment, different degrees of translucency can be provided for regions within a single page, such as via pixel alpha blending techniques.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A method of providing video enhancement to an interactive content page, the method comprising:
providing a graphical overlay with a plurality of transparent sections;
providing a graphical underlay capable to show a plurality of underlay contents;
displaying a first underlay content in a first one of the transparent sections; and
displaying a second underlay content in a second one of the transparent sections in sequence after displaying the first underlay content.

2. The method of claim 1, further comprising prior to providing the graphical overlay, tuning to a first channel for broadcasting the graphical overlay.

3. The method of claim 1, further comprising prior to displaying the first underlay content, tuning to a second channel for broadcasting the first underlay content.

4. The method of claim 1 wherein the graphical overlay is transmitted over a first channel.

5. The method of claim 1 wherein the plurality of underlay contents are transmitted over a second channel.

6. The method of claim 5 wherein the plurality of underlay contents are broadcast in a single composite signal.

7. The method of claim 1 wherein the plurality of underlay contents are transmitted from a broadcast center.

8. The method of claim 1 wherein the second underlay content is substantially blocked from view through the second transparent section when the first underlay content is shown through the first transparent section.

9. The method of claim 1 wherein the first underlay content is substantially blocked from view through the first transparent section when the second underlay content is shown through the second transparent section.

10. The method of claim 1, further comprising displaying a subsequent underlay content in one of the transparent sections in sequence after displaying at least one of the first underlay content and second underlay content.

11. The method of claim 10 wherein the subsequent underlay content is transmitted over a third channel

12. The method of claim 1, further comprising tracking a showing through the first transparent section by the first underlay content.

13. The method of claim 12, further comprising:
removing the graphical overlay from view;
subsequently showing the graphical overlay; and
showing an underlay content that has not been previously shown through a transparent section of the interactive content page.

14. The method of claim 1 wherein at least one of the underlay contents is related to a user preference data.

15. An article of manufacture, comprising:
a machine-readable medium having stored thereon instructions to:
provide a graphical overlay with a plurality of transparent sections;
provide a graphical underlay capable to show a plurality of underlay contents;
display a first underlay content in a first one of the transparent sections; and
display a second underlay content in a second one of the transparent sections in sequence after displaying the first underlay content.

16. A method of providing video enhancement to an interactive content page, the method comprising:
providing a graphical overlay with a transparent section;
providing a graphical underlay capable to show at least one underlay content;
displaying a first underlay content through the transparent section; and
subsequently displaying a second underlay content through the transparent section.

17. The method of claim 16, further comprising prior to providing the graphical overlay, tuning to a first channel for broadcasting the graphical overlay.

18. The method of claim 16, further comprising prior to displaying the first underlay content, tuning to a second channel for broadcasting the first underlay content.

19. The method of claim 16 wherein the graphical overlay is transmitted over a first channel.

20. The method of claim 16 wherein the first underlay content is transmitted over a second channel.

21. The method of claim 16 wherein the underlay contents are transmitted from a broadcast center.

22. The method of claim 16 wherein the underlay contents are transmitted from a storage device.

23. The method of claim 16, further comprising tracking a showing through the transparent section by the first underlay content.

24. The method of claim 23, further comprising:
removing the graphical overlay from view;
subsequently showing the graphical overlay; and
showing an underlay content that has not been previously shown through the transparent section of the interactive content page.

25. The method of claim 16 wherein at least one of the underlay contents is related to a user preference data.

26. An article of manufacture, comprising:
a machine-readable medium having stored thereon instructions to:
provide a graphical overlay with a transparent section;
provide a graphical underlay capable to show at least one underlay content;
display a first underlay content through the transparent section; and
subsequently display a second underlay content through the transparent section.

27. A method of providing video enhancement to an interactive content page, the method comprising:
showing an interactive content page and a first underlay content through a transparent section of the interactive content page;
tracking an event of showing the first underlay content through the transparent section;
removing the interactive content page from view; and
showing the interactive content page and a second underlay content through the transparent section of the interactive content page, where the second underlay content has not been shown through the transparent section.

28. The method of claim 27 wherein at least the first or the second underlay content is based on user preference data.

29. A method of providing video enhancement to an interactive content page, the method comprising:
showing an interactive content page with multiple transparent sections and showing a first underlay content through a first one of the multiple transparent sections;
tracking an event of showing the first underlay content;
removing the interactive content page from view;
subsequently showing the interactive content page and a second underlay content through a second one of the multiple transparent sections, where the second underlay content has not yet been shown through a transparent section in the interactive content page.

30. The method of claim 29 wherein at least the first or the second underlay content is based on user preference data.

31. A method of providing video enhancement to an interactive content page, the method comprising:
tracking user preference data indicating a preference of a user;
storing the user preference data;
showing an interactive content page with a transparent section and determining the preference of the user based upon the user preference data;
showing an underlay content through the transparent section, where the underlay content is related to the user preference data;
showing a second underlay content through the transparent section in sequence after the first underlay content, where the second underlay content is related to the user preference data.

32. The method of claim 31 wherein the user preference data is stored in a broadcast center.

33. The method of claim 31 wherein the user preference data is stored in a local storage device.

34. The method of claim 31 wherein the tracking of user preference data comprises tracking an activity of the user indicating the preference of the user.

35. The method of claim 31 wherein the tracking of the user preference data comprises providing, by the user, information relating to the preference of the user.

36. The method of claim 31 wherein the interactive content page includes a translucent section through which to show third underlay content.

37. The method of claim 31 wherein the interactive content page includes a plurality of transparent sections, the method further comprising showing an underlay content in an associated transparent section, where at least one of the underlay contents is related to the user preference data.

38. An apparatus for providing video enhancement to an interactive content page, the apparatus comprising:
a display engine capable to display a graphical overlay having a plurality of transparent sections, where a first underlay content is displayed in a first one of the transparent sections and a second underlay content is displayed in a second one of the transparent sections in sequence after displaying the first underlay content; and
a processor communicatively coupled to the display engine and capable to execute the display engine.

39. The apparatus of claim 38, further comprising a tuner system communicatively coupled to the display engine and configured to tune to a first channel for broadcasting the graphical overlay and to tune to a second channel for broadcasting the plurality of underlay contents.

40. The apparatus of claim 38 wherein the plurality of underlay contents are broadcast in separate channels.

41. The apparatus of claim 38 wherein the plurality of underlay contents are transmitted from a broadcast center.

42. The apparatus of claim 38 wherein the second underlay content is substantially blocked from view through the second transparent section when the first underlay content is shown through the first transparent section.

43. The apparatus of claim 38 wherein the first underlay content is substantially blocked from view through the first transparent section when the second underlay content is shown through the second transparent section.

44. The apparatus of claim 38, wherein a subsequent underlay content is displayed in one of the transparent sections in sequence after displaying at least one of the first underlay content and second underlay content.

45. The apparatus of claim 44 wherein the subsequent underlay content is transmitted over a third channel

46. The apparatus of claim 38, wherein the display engine is configured to track a showing through the first transparent section by the first underlay content.

47. The apparatus of claim 46, wherein the display engine is configured to remove the graphical overlay from view, subsequently show the graphical overlay, and show an underlay content that has not been previously shown through a transparent section of the interactive content page.

48. The apparatus of claim 38 wherein at least one of the underlay contents is related to a user preference data.

49. The apparatus of claim 38 wherein the display engine is capable to display the first underlay content through one of the transparent sections and the second underlay content through that transparent section in sequence after the first underlay content.

50. The apparatus of claim 38 wherein at least one of the underlay contents is related to a user preference data.

51. An apparatus for providing video enhancement to an interactive content page, the apparatus comprising:
a display engine configured to track user preference data indicating a preference of a user, to store the user preference data, to show an interactive content page with a plurality of transparent sections and determine the preference of the user based upon the user preference data, and to show an underlay content in an associated transparent section, where at least one of the underlay contents is related to the user preference data.

52. The apparatus of claim 51 wherein the display engine is capable to sequentially show underlay content in corresponding ones of the transparent section, wherein one underlay content is shown after presentation of a previous underlay content based on a trigger that demarcates an end of the previous underlay content.

53. An apparatus for providing video enhancement to an interactive content page, the apparatus comprising:
means for providing a graphical overlay with a plurality of transparent sections and for providing a graphical underlay capable to show a plurality of underlay contents; and
communicatively coupled to the providing means, means for displaying a first underlay content in a first one of the transparent sections, and for displaying a second underlay content in a second one of the transparent sections in sequence after displaying the first underlay content.
